(19) United States
(12) Patent Application Publication
(10) Pub. No.: US 2010/0002886 A1
(43) Pub. Date: Jan. 7, 2010

(54) HEARING SYSTEM AND METHOD IMPLEMENTING BINAURAL NOISE REDUCTION PRESERVING INTERAURAL TRANSFER FUNCTIONS

(75) Inventors: Simon Doclo, Schilde (BE); Thomas J. Klasen, Bethesda, MD (US); Marc Moonen, Herent (BE); Tim Van Den Bogaert, Kapellen (BE); Jan Wouters, Holsbeek (BE); Ralph Peter Derleth, Hinwil (CH); Sascha Korl, Sargans (CH)

Correspondence Address: PEARNE & GORDON LLP, 1801 EAST 9TH STREET, SUITE 1200, CLEVELAND, OH, 44114-3108, US

(73) Assignee: PHONAK AG, Staefa (CH)

(21) Appl. No.: 12/299,945

(22) PCT Filed: May 9, 2007
(86) PCT No.: PCT/EP2007/054468

§ 371 Date: May 1, 2009

(30) Foreign Application Priority Data
May 10, 2006 (GB) 0609248.0

(51) Int. Cl. H04R 5/00; H04R 29/00

(52) U.S. Cl. 381/23.1; 381/60

(57) ABSTRACT

The binaural hearing system (1) comprises
ITF means (3a;3b) for providing at least one interaural transfer function (30a;30b);
noise reduction means (5a;5b) for performing noise reduction in dependence of said at least one interaural transfer function.

The method of operating a binaural hearing system (1) comprises the steps of
providing at least one interaural transfer function (30a;30b);
performing noise reduction in dependence of said at least one interaural transfer function.

Preferably, said noise reduction means (5a;5b) comprises two binaural Wiener filters (5a,5b) each having a cost function comprising at least one term describing a desired interaural transfer function, wherein said at least one interaural transfer function provided by said ITF means (3a,3b) is assigned to said at least one term. Preferably, said cost function comprises a speech distortion term, a residual noise term and two ITF terms for preserving the interaural transfer functions of speech and noise components. This allows to preserve binaural cues while reducing noise.

### TECHNICAL FIELD

The invention relates to the field of binaural hearing systems, and in particular to noise reduction in such hearing systems. It relates to methods and apparatuses according to the opening clauses of the claims.

Rather specifically, the present invention relates to binaural noise reduction through Wiener Filtering for hearing aids preserving interaural transfer functions (ITF), and more particularly it relates to an algorithm for preserving interaural transfer functions of the speech and noise components and thus preserving the interaural time delay (ITD) and interaural level difference (ILD) cues of the speech and noise components.

### DEFINITIONS

Under a hearing device, a device is understood, which is worn in or adjacent to an individual's ear with the object to improve the individual's acoustical perception. Such improvement may also be barring acoustic signals from being perceived in the sense of hearing protection for the individual. If the hearing device is tailored so as to improve the perception of a hearing impaired individual towards hearing perception of a “standard” individual, then we speak of a hearing-aid device. A hearing-aid device is also referred to as hearing aid. With respect to the application area, a hearing device may be applied behind the ear, in the ear, completely in the ear canal or may be implanted.

A hearing system comprises at least one hearing device. In case that a hearing system comprises at least one additional device, all devices of the hearing system are operationally connectable within the hearing system. Typically, said additional devices such as another hearing device, a remote control or a remote microphone, are meant to be worn or carried by said individual.

Under audio signals, we understand electrical signals, analogue and/or digital, which represent sound.

An interaural transfer function (ITF) is a function describing how to obtain a signal representing sound originating from one sound source and picked up in or near one ear of an individual, from a signal representing the identical sound (originating from the identical sound source) picked up in or near the other ear of said individual. An ITF can, e.g., be obtained by dividing data representing said signals picked up in or near said one ear by data representing said signals picked up in or near said other ear. An ITF is actually defined only for one single sound source, but it is nevertheless also used for a mixture of signals originating from two or more sound sources, as long as signals from one of the sources prevail over signals from other sources.

We understand under technical “beam-forming” tailoring the amplification of an electrical signal with respect to an acoustical signal as a function of direction of arrival (DOA) of the acoustical signal relative to a predetermined spatial direction. Most generically, technical beam-forming is always achieved when the output signals of two spaced input acoustical-to-electrical converter arrangements are processed to result in a combined output signal. Within the field of a binaural hearing systems, we understand under technical “monaural beam-forming”, the beam-forming as performed separately at the respective hearing devices. Under “binaural beam-forming”, we understand within this field beam-forming which exploits the mutual distance between an individual's ears.

### BACKGROUND OF THE INVENTION

Hearing impaired persons localize sounds better without their bilateral hearing aids than with them [2]. In addition, noise reduction algorithms currently used in hearing aids are not designed to preserve localization cues [3]. The inability to correctly localize sounds puts the hearing aid user at a disadvantage. The sooner the user can localize a speech signal, the sooner the user can begin to exploit visual cues. Generally, visual cues lead to large improvements in intelligibility for hearing impaired persons [4]. Furthermore, preserving the spatial separation between the target speech and the interfering signals leads to an improvement in speech understanding [5], [6].

Studies have shown that the spatial separation between the speech and noise sources contributes to an improvement in intelligibility [5], [6]. This is referred to as spatial release from masking. Therefore the benefit of a noise reduction algorithm that preserves localization cues is twofold. First, noise reduction leads to an improvement in intelligibility. Additionally, preserving localization cues preserves the spatial separation of the target speech and noise sources, resulting again in an improvement in intelligibility.

A hearing impaired person wearing a monaural hearing aid on each ear is said to be using bilateral hearing aids. Each monaural hearing aid uses its own microphone inputs to generate an output for its respective ear. No information is shared between the hearing aids. Contrastingly, binaural hearing aids use the microphone inputs from both the left and right hearing aid, typically through a wireless link, to generate an output for the left and right ear.

Interaural time delay (ITD) and interaural level difference (ILD) help listeners localize sounds horizontally [7]. ITD is the time delay in the arrival of the sound signal between the left and right ear, and ILD is the intensity difference between the two ears. ITD cues are more reliable in low frequencies.

On the other hand, ILD is more prominent in high frequencies, since it stems from the scattering of the sound waves by the head.

In [8], the Wiener filter cost function used in a noise reduction procedure has been extended, and includes terms related to ITD and ILD cues of the noise component. The ITD cost function is expressed as the phase difference between the output noise cross-correlation and the input noise cross correlation. The ILD cost function is expressed as the difference between the output noise power ratio and the input noise power ratio. It has been shown that it is possible to preserve the binaural cues of both the speech and noise components without significantly compromising the noise reduction performance. However, iterative optimization techniques are used to compute the filter.

It is desirable to provide for an improved noise reduction in hearing systems.

Several documents are cited throughout the text of this specification. Each of the documents herein (including any manufacturer's specifications, instructions etc.) are hereby incorporated by reference; however, there is no admission that any document cited is indeed prior art of the present invention.

### SUMMARY OF THE INVENTION

Therefore, one object of the invention is to create a binaural hearing system that does not have the disadvantages mentioned above. It shall be provided for an improved noise reduction.

In addition, the respective method of operating a binaural hearing system shall be provided.

Another object of the invention is to provide for a way to achieve an improved speech intelligibility, in particular in noisy environments.

Another object of the invention is to provide for an alternative way of providing localization cues while performing noise reduction in a hearing system.

Further objects emerge from the description and embodiments below.

At least one of these objects is at least partially achieved by apparatuses and methods according to the patent claims.

The binaural hearing system comprises
ITF means for providing at least one interaural transfer function;
noise reduction means for performing noise reduction in dependence of said at least one interaural transfer function.

Through this, an improved noise reduction can be achieved. In particular, this allows to provide for localization cues while performing noise reduction. An improved speech intelligibility can be achieved.

The corresponding method of operating a binaural hearing system comprises the steps of
providing at least one interaural transfer function;
performing noise reduction in dependence of said at least one interaural transfer function.

Said ITF means can be a means providing said at least one interaural transfer function.

In one embodiment, said ITF means also allows to obtain said at least one interaural transfer function, e.g., by calculating.

Said ITF means can be or comprise a storage means comprising predefined, e.g., pre-calculated data describing said at least one interaural transfer function.

Said noise reduction means can be means performing said noise reduction in dependence of said at least one interaural transfer function.

In one embodiment, said at least one interaural transfer function comprises an interaural transfer function of wanted signal components and/or an interaural transfer function of unwanted signal components. It may comprise two or more interaural transfer functions of wanted signal components and/or two or more interaural transfer functions of unwanted signal components. In most practical cases, there will be one source of wanted signals and, accordingly, one interaural transfer function of wanted signal components, and one or two sources of unwanted signals and, accordingly, one or two interaural transfer functions of wanted signal components.

We occasionally speak of wanted/unwanted signal “components”, in order to emphasize that signals subject to noise reduction are a composition of wanted signals and unwanted signals. The primary aim of said noise reduction is to separate wanted signal components from unwanted signal components.

Typically, said wanted signals are speech signals. Said unwanted signals are often referred to as noise.

In one embodiment, said binaural hearing system comprises
a first and a second input transducer unit;
   said ITF means having an ITF output for outputting said at least one interaural transfer function, and said noise reduction means comprising a first and a second adaptive filtering unit, each having at least a first and a second audio signal input and a control input, for filtering audio signals inputted to said audio signal inputs in dependence of data received at said control input, wherein each of said first audio signal inputs is operationally connected to said first input transducer unit and each of said second audio signal inputs is operationally connected to said second input transducer unit, and wherein each of said control inputs is operationally connected to said ITF output.

In one embodiment, said first adaptive filtering unit is a first adaptive filter, and said second adaptive filtering unit is a second adaptive filter.

Said ITF means can also be referred to as an ITF unit.

In one embodiment, each input transducer unit comprises at least one input transducer. Input transducers are usually acoustic-to-electric converters, e.g., microphones.

In one embodiment, said binaural hearing system comprises a first and a second hearing device, each comprising an input transducer belonging to said first and second input transducer unit, respectively.

An input transducer unit may comprise a remote input transducer such as a remote microphone.

Typically, said first and said second input transducer units each comprise at least one input transducer that is worn in or near the left and right ear, respectively, of an individual using said binaural hearing system.

In one embodiment, said filtering in said first and second adaptive filtering units depends in essentially the same way on said at least one interaural transfer function. More particularly, the optimization functions of said first and second adaptive filtering units are identical, i.e. have the same form. (Note that differences between filtering and filtering coefficients in said first and second adaptive filtering units is due to the assignment of different audio signals to the inputs of said first and second adaptive filtering units, respectively.

In one embodiment, said first and second adaptive filtering units each have a set of filtering coefficients, which depend on said at least one interaural transfer function.

We refer to filtering coefficients of an adaptive filter as coefficients (or terms), which influence the way the adaptive filter filters the signals inputted to the filter.

In one embodiment, said first and second adaptive filtering units each have an optimization function depending on said at least one interaural transfer function. For Wiener filters, said optimization function is typically referred to as “cost function”. In case of a constraint optimization, the functional expression describing the constraint is—in the framework of the present application—considered to be comprised in said optimization function.

In one embodiment, said binaural hearing system comprises
a first and a second output transducer unit for receiving audio signals and converting these into signals to be perceived by an individual using said binaural hearing system;
   said first adaptive filtering unit comprising an audio signal output operationally connected to said first output transducer unit, and said second adaptive filtering unit comprising an audio signal output operationally connected to said second output transducer unit.

In one embodiment, said first and second output transducer units are each comprised in one device of said binaural hearing system, in particular in a hearing device.

In one embodiment, said first and second output transducer units are are located in or near the left and the right ear, respectively, of said individual during normal operation of said binaural hearing system.

Typically, such output transducer units are embodied as loudspeakers, also referred to as receivers.

In one embodiment, said first and second adaptive filtering units each have an optimization function comprising at least one term describing at least one desired interaural transfer function, such as to aim at outputting audio signal components from said first and second adapative filtering units, respectively, which are related to each other as described by said at least one desired interaural transfer function. In particular:

In one embodiment, said first and second adaptive filtering units each have an optimization function comprising a first term describing a desired interaural transfer function for wanted signal components and a second term describing a desired interaural transfer function for unwanted signal components, such as to aim at realizing that a transfer function describing the relation between wanted audio signal components outputted from said first and second adapative filtering units, respectively, corresponds to said desired interaural transfer function for wanted signal components, and at realizing that a transfer function describing the relation between unwanted audio signal components outputted from said first and second adapative filtering units, respectively, corresponds to said desired interaural transfer function for unwanted signal components.

Of course, as indicated above, there may be additional terms in said optimization function, for further wanted and/or (more likely) unwanted signal components.

In one embodiment, said ITF means comprises a first and a second input, for obtaining an interaural transfer function from audio signals inputted to said first and second inputs, wherein said first and second inputs are operationally connected to said first and second input transducer unit, respectively.

In this embodiment, it is possible to preserve at least one ITF. Through this, the localization cues in the filtered signals are similar to or even at least approximately the same as the localization cues in the unfiltered signals.

It is also possible to use other ITFs. This allows to virtually locate sources of sound. E.g., instead of preserving the ITF for unwanted signal components, an ITF corresponding to a source from sideways behind the hearing system user's head can be used, which can lead to an enhanced intelligibility, in particular if the actual source of noise is located in a direction close to the direction where the source of wanted signals is located, which is usually expected to be in direction of said user's nose.

In one embodiment, said binaural hearing system comprises at least one detecting unit operationally connected to at least one of said first and second input transducer units, and having an output operationally connected to said control input of at least one of said first and second adaptive filters, for deciding whether audio signals received from said at least one of said input transducer units are considered wanted signals or unwanted signals.

Said detecting unit can comprise a voice activity detector.

Said detecting unit may be based on at least one of frequency spectrum analysis, a directional analysis, e.g., as a localizer does, or classification, also referred to as acoustic scene analysis.

In case that said first and second adaptive filtering units each have an optimization function comprising a first term describing a desired interaural transfer function for wanted signal components and a second term describing a desired interaural transfer function for unwanted signal components, this embodiment provides a good way to allow to assign said obtained interaural transfer function to either said first or said second term.

In one embodiment, said first and second adaptive filtering units comprise at least one Wiener filter each, in particular multichannel Wiener filters.

It is also possible to use other types of filters. E.g., filters based on blind source separation (BSS) can be used.

In general, preferably, linear filters are used. With respect to other filters, they have the advantage of providing good results at relatively low computational cost. Instead of implementing at least one desired ITF in a filter's optimization function, it is also possible to perform a constraint optimization. Said constraint can in this case aim at accomplishing that a relation between audio signals output from said first and second filtering units corresponds to a desired interaural transfer function.

In one embodiment, said noise reduction means comprises two binaural Wiener filters each having a cost function comprising at least one term describing a desired interaural transfer function, in particular wherein said at least one interaural transfer function provided by said ITF means is assigned to said at least one term.

In one embodiment, said binaural hearing system comprises
a first and a second device;
a first and a second input transducer unit, said first input transducer unit comprising at least two input transducers;
a preprocessing unit comprising at least two audio signal inputs operationally connected to one of said at least two input transducers each, and comprising an audio signal output for outputting preprocessed audio signals obtained by processing audio signals received at said at least two audio signal inputs;
a sending unit comprised in said first device and operationally connected to said audio signal output of said preprocessing unit;
a receiving unit comprised in said second device and operationally connectable to said sending unit via a communication link;
   said noise reduction means comprising an adaptive filtering unit having at least a first and a second audio signal input, for filtering audio signals inputted to said audio signal inputs, wherein said first audio signal input is operationally connected to said receiving unit, and said second audio signal input is operationally connected to said second input transducer unit.

This can be valuable, in particular when the bandwith for transmitting data from said sending unit to said receiving unit is limited, in particular when the bandwidth allows to transmit one audio signal stream, but not two audio signal streams in the desired quality (defined, e.g., by bit-depth and sampling frequency). Said processing in said preprocessor typically combines the two or more audio signal streams input to the preprocessor into a smaller number of audio signal streams, typically into only one audio signal stream. But it is also possible to provide that a preprocessor outputs the same number of audio signal streams may as are inputted to the preprocessor. In the latter case, the preprocessor typically performs compression of audio signals.

In one embodiment, said preprocessor performs beamforming, more precisely technical beamforming, typically monaural beamforming, e.g., by delaying one input signal stream with respect to another input signal stream and adding the two, possibly inverting one of the signals, i.e. by the well-known delay-and-add method for beamforming. It is also possible to perform the well-known filter-and-add method by delaying one input signal stream with respect to another input signal stream and frequency-bin-wise adding the two, weighting the frequency bins, and possibly inverting one of the signals.

In one embodiment, said preprocessor performs compression, in particular perceptual coding, i.e. a compression making use of the fact that certain components of audio signals are not or hardly perceivable by the human ear, which therefore can be omitted. It is also possible to use a compression that makes use of the fact that audio signals picked up by closely-spaced input transducers are very similar. Components in said audio signals that are identical or practically identical can be omitted in one of the preprocessed audio signals. And components that can be derived from one preprocessed audio signal stream also need not be comprised in another preprocessed audio signal stream. Said closely-spaced input transducers can comprise input transducers comprised in the same device of the binaural hearing system, and it is also possible to provide that said closely-spaced input transducers can comprise input transducers comprised in the same device of the binaural hearing system.

In one embodiment, said preprocessor is, at least in part, comprised in said noise reduction means. It is possible to use intermediate results of said noise reduction means or audio signals derived therefrom, as preprocessed audio signals.

Said communication link is typically a wireless communication link, but can also be a wire-bound or other communication link, e.g., one making use of skin conduction.

Said first and/or second device of said binaural hearing system can be, e.g., hearing device, or remote control, or wearable processing unit, or remote microphone unit.

In one embodiment, said binaural hearing system comprises
a first and a second hearing device;
a first and a second input transducer unit comprised in said first and second hearing device, respectively, each comprising at least two input transducers;
a first preprocessing unit comprised in said first hearing device, comprising at least a first and a second audio signal input, each operationally connected to one of said at least two input transducers of said first input transducer unit, and comprising an audio signal output for outputting preprocessed audio signals obtained by preprocessing audio signals received at said first and second audio signal inputs;
a second preprocessing unit comprised in said second hearing device, comprising at least a first and a second audio signal input, each operationally connected to one of said at least two input transducers of said second input transducer unit, and comprising an audio signal output for outputting preprocessed audio signals obtained by preprocessing audio signals received at said first and second audio signal inputs;
a first sending unit comprised in said first hearing device, and operationally connected to said audio signal output of said first preprocessing unit;
a second sending unit comprised in said second hearing device, and operationally connected to said audio signal output of said second preprocessing unit;
a first receiving unit comprised in said first device and operationally connectable to said second sending unit via a communication link;
a second receiving unit comprised in said second device and operationally connectable to said first sending unit via a communication link;
   said noise reduction means comprising a first and a second adaptive filtering unit, each having at least a first and a second audio signal input, for filtering audio signals inputted to said audio signal inputs, wherein
said first audio signal input of said first adaptive filtering unit is operationally connected to said first input transducer unit;
said second audio signal input of said first adaptive filtering unit is operationally connected to said first receiving unit;
said first audio signal input of said second adaptive filtering unit is operationally connected to said second receiving unit;
said second audio signal input of said second adaptive filtering unit is operationally connected to said second input transducer unit.

As pointed out before, said communication links are typically wireless communication links, but can also be other communication links.

In one embodiment, said ITF means is comprised in one device of said binaural hearing system, and said at least one interaural transfer function provided by said ITF means, or a portion thereof, is transmitted to another device of said binaural hearing system.

In another embodiment, said ITF means comprises two sub-units comprised in different devices of said binaural hearing system, and each providing at least one interaural transfer function. This can allow to render a transmission of at least one interaural transfer function from one device of said binaural hearing system to another device of said binaural hearing system superfluous.

Said noise reduction means and said ITF means and said preprocessor and said detecting unit are typically implemented in at least one processor, typically a programmable processor, in particular a signal processor, usually a digital signal processor (DSP). Their functions can be realized in one such processor, but typically they will be distributed over at least two such processors.

In one embodiment, said noise reduction means are or comprise two binaural Wiener filters, each having a cost function J(W) as follows

$$J ( W ) = ɛ \{ \begin{matrix}{‖ [ \begin{matrix}{X}_{{L}_{0}} - {W}_{L}^{H} X \\ {X}_{{R}_{0}} - {W}_{R}^{H} X\end{matrix} ] ‖}^{2} + μ {‖ [ \begin{matrix}{W}_{L}^{H} X \\ {W}_{R}^{H} X\end{matrix} ] ‖}^{2} + \\ α \frac{{\vert {W}_{L}^{H} X - I T {F}_{{X}_{des}} {W}_{R}^{H} X \vert}^{2}}{{‖ ⌈ \begin{matrix}I T {F}_{{X}_{des}} \\ 1\end{matrix} ⌉ ‖}^{2}} + \\ β \frac{{\vert {W}_{L}^{H} V - I T {F}_{{V}_{des}} {W}_{R}^{H} V \vert}^{2}}{{‖ ⌈ \begin{matrix}I T {F}_{{V}_{des}} \\ 1\end{matrix} ⌉ ‖}^{2}}\end{matrix} \}$$

wherein the meaning of all the variables is explained in the Examples I to III in the Detailed Description of the Invention below.

A great advantage of this cost function is, that its minimum can be derived analytically, and the corresponding optimum filtering coefficients W can be obtained from measurable data. In the formulae depicted after equation (1) in the Detailed Description of the Invention (Example III, section B), said optimum filtering coefficients W are explicitely given.

In one embodiment of said method of operating a binaural hearing system, said binaural hearing system comprises a first and a second input transducer unit and a first and a second adaptive filtering unit, and said method comprises the steps of
obtaining first audio signals by means of said first input transducer unit;
obtaining second audio signals by means of said second input transducer unit;
inputting said first audio signals or audio signals derived therefrom to said first adaptive filtering unit and to said second adaptive filtering unit;
inputting said second audio signals or audio signals derived therefrom to said first adaptive filtering unit and to said second adaptive filtering unit;
in said first and said second adaptive filtering units: filtering said audio signals inputted to the corresponding adaptive filtering unit in dependence of said least one interaural transfer function.

In one embodiment of said method of operating a binaural hearing system, said filtering in said first and second adaptive filtering units depends in essentially the same way on said at least one interaural transfer function.

In one embodiment, said method comprises the steps of
converting audio signals obtained by said filtering in said first adaptive filtering unit or audio signals derived therefrom into signals to be perceived by an individual using said binaural hearing system;
converting audio signals obtained by said filtering in said second adaptive filtering unit or audio signals derived therefrom into signals to be perceived by said individual.

In one embodiment, said method comprises the step of obtaining said at least one interaural transfer function from calculating a relation between said first audio signals or audio signals derived therefrom and said second audio signals or audio signals derived therefrom.

In one embodiment, said method comprises the steps of
analyzing said first audio signals and/or said second audio signals and/or audio signals derived from said first and/or said second audio signals;
based on the result of this analysis: generating an indication whether the analyzed audio signals are considered wanted signals or unwanted signals.

In one embodiment, said first and second adaptive filtering units each have an optimization function comprising a first term describing a desired interaural transfer function for wanted signal components and a second term describing a desired interaural transfer function for unwanted signal components, said method comprising the step of
assign—based on said indication—said obtained interaural transfer function to either said first or said second term.

In one embodiment, said first and second adaptive filtering units both perform Wiener filtering.

In one embodiment, said binaural hearing system comprises a first and a second device and a first and a second input transducer unit and an adaptive filtering unit having at least a first and a second audio signal input, said first input transducer unit comprising at least two input transducers, said method comprising the steps of
obtaining preprocessed audio signals by processing audio signals derived by each of said at least two input transducers;
transmitting said preprocessed audio signals from said first to said second device;
after said transmission: feeding said preprocessed audio signals or signals derived therefrom to said first audio signal input;
feeding audio signals obtained by said second input transducer unit or signals derived therefrom to said second audio signal input;
performing noise reduction by filtering audio signals inputted to said audio signal inputs of said adaptive filtering unit.

It has been found, that in many noise reduction systems, wanted signals are subject to relatively low distortion, and for that reason, the ITF of wanted signals is usually not severely distorted. But, since it is the task of a noise reduction system to suppress unwanted signal components, the ITF of unwanted signal components is usually relatively strongly distorted by noise reduction algorithms. It has been found that providing unwanted signal components with a well-defined ITF (be it an artificial ITF or an ITF derived from the original signals) can significantly enhance the intelligibility of the noise reduced signals. The present invention allows to provide wanted and/or unwanted signal components with a well-defined ITF.

The advantages of the methods correspond to the advantages of corresponding apparatuses.

The present invention can solve problems of the related art of binaural cue preservation by preserving the ITFs of the speech and noise component.

In a specific view, the invention is drawn to an algorithm which preserves both the interaural time delay (ITD) and interaural level difference (ILD) of the speech and noise components. This is achieved by preserving the ITFs of wanted signal components (speech component) and unwanted signal components (noise component). Clearly, the interaural transfer function (ITF), which is the ratio between the speech components (noise components) in the microphone signals at the left and right ear, captures all information between the two ears including ITD and ILD cues.

Viewed from a certain angle, present invention attacks the problem of binaural cue preservation by preserving the ITF. If the algorithm preserves the ITFs of the speech and noise components then the algorithm preserves the ITD and ILD cues of the speech and noise components.

More particularly the present invention concerns an improvement of the binaural multi-channel Wiener filtering based noise reduction algorithm by extending the underlying cost function to incorporate terms for the interaural transfer functions (ITF) of the speech and noise components, which improvement preserves both the interaural time delay (ITD) and interaural level difference (ILD) of the speech and noise components. Using weights, the emphasis on the preservation of the ITFs can be controlled in addition to the emphasis on noise reduction. Adapting these parameters allows one to preserve the ITFs of the speech and noise component, and therefore ITD and ILD cues, while enhancing the signal-to-noise ratio.

Viewed from a certain point of view, by present invention a binaural noise reduction algorithm has been designed and provided that allows one to control the ITD and ILD cues.

In a further aspect of the invention, the desired ITFs can be replaced by known ITFs for a specific direction of arrival. Preserving these desired ITFs allows one to change the direction of arrival of the speech and noise sources. Furthermore, an algorithm that intentionally distorts the localization cues of the speech and noise sources to improve the spatial separation of speech and noise could lead to improvements in intelligibility.

Considered under a specific point of view, the present invention provides a binaural Wiener filter based noise reduction procedure improved by incorporating two terms in the cost function that account for the ITFs of the speech and noise components. Using weights, the emphasis on the preservation of the ITF of the speech and noise component can be controlled in addition to the emphasis on noise reduction.

Adapting theses parameters allows one to preserve the ITF of the speech and noise component, and therefore ITD and ILD cues, while enhancing the signal-to-noise ratio. Additionally, it has been shown that the algorithm can even shift the noise source to a new location, by using a different desired ITF for the noise source, while maintaining good noise reduction performance.

Present invention is, in a certain aspect, an improvement of the binaural Wiener filter described in [1], where the cost function is comprised of four terms. The first two terms are present in the monaural speech distortion weighted Wiener filter proposed by [9]. The remaining two terms aim at preserving the ITFs of the speech and noise component. Contrary to the Wiener filter extensions proposed in [1], this algorithm co-designs the right and left filter. In other words, the left and right filter are related to each other in that they have common dependencies.

Further scope of applicability of the present invention will become apparent from the detailed description given hereinafter. However, it should be understood that the detailed description and specific examples, while indicating specific embodiments of the invention, are given by way of illustration only, since various changes and modifications within the spirit and scope of the invention will become apparent to those skilled in the art from this detailed description. It is to be understood that both the foregoing general description and the following detailed description are exemplary and explanatory only and are not restrictive of the invention, as claimed.

Further preferred embodiments and advantages emerge from the dependent claims and the figures.

### BRIEF DESCRIPTION OF THE DRAWINGS

Below, the invention is described in more detail by means of examples and the included drawings. The present invention will become more fully understood from the detailed description given herein below and the accompanying drawings which are given by way of illustration only, and thus are not limitative of the present invention, and wherein:

FIG. 1 is a schematic view of a binaural hearing aid user in a typical listening scenario

FIG. 2 is a graphic display of the decomposition of residual noise vector

FIG. 3 demonstrates the Absolute ITD Error

FIG. 4 displays the Mean squared error ILD

FIG. 5 displays the improvement in Speech Intelligibility Weighted SNR

FIG. 6 ITF Error

FIG. 7 improvement in Speech Intelligibility Weighted SNR with desired noise ITF located at 225°

FIG. 8 ITF Error with desired noise ITF located at 225°

FIG. 9 is a block-diagrammatical illustration of an embodiment with voice activity detection;

FIG. 10 is a block-diagrammatical illustration of an embodiment with preprocessors and two ITF units;

FIG. 11 is a block-diagrammatical illustration of a detail of an embodiment with preprocessing and wireless transmission;

FIG. 12 is a block-diagrammatical illustration of an embodiment with preprocessors and one ITF unit;

FIG. 13 is a block-diagrammatical illustration of an embodiment with preprocessors comprised in filtering units.

The reference symbols used in the figures and their meaning are summarized in the list of reference symbols. The described embodiments are meant as examples and shall not confine the invention.

### DETAILED DESCRIPTION OF THE INVENTION

The following detailed description of the invention refers to the accompanying drawings. Also, the following detailed description does not limit the invention. Instead, the scope of the invention is defined by the appended claims and equivalents thereof.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

### Examples

In Example I, the system model is introduced. Additionally, the notation used in this paper is presented. The ITF is defined in Example II. In Example III, the original speech distortion weighted binaural Wiener filtering cost function is reviewed. Next, the cost function is extended by adding two terms to control the ITFs of the speech and noise component. Performance measures and the experimental setup are presented in Example IV.

### Example I

### System Model

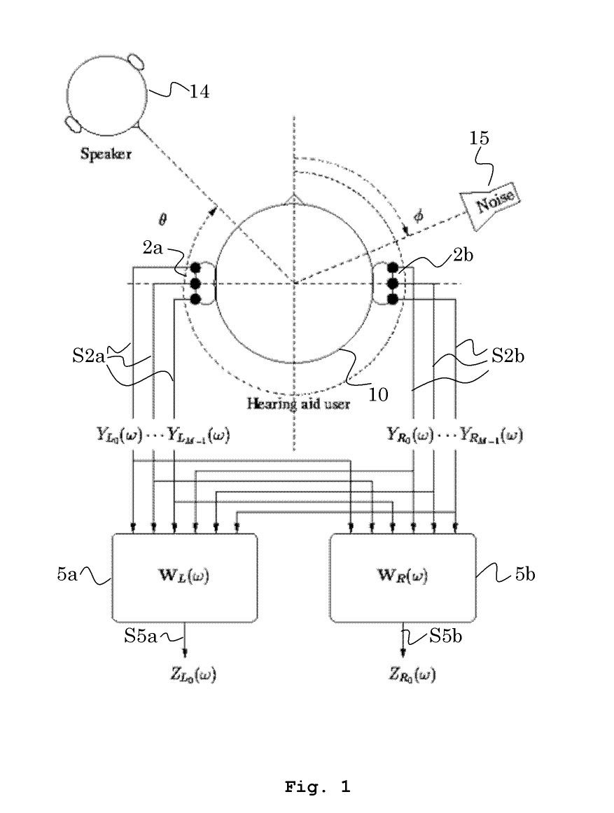

FIG. 1 shows a binaural hearing aid user in a typical listening scenario. The speaker speaks intermittently in the continuous background noise caused by the noise source. There are M microphones on each hearing aid. We refer to the mth microphone of the left hearing aid and the mth microphone of the right hearing aid as the mth microphone pair. The received signals at the mth microphone pair are expressed in frequency domain below.

Y_{L}_{ₘ}(ω)=X_{L}_{ₘ}(ω)+V_{L}_{ₘ}(ω) (1)

Y_{R}_{ₘ}(ω)=X_{R}_{ₘ}(ω)+V_{R}_{ₘ}(ω) (2)

In (1) and (2), X_{Lm}(ω) and X_{Rm}(ω) represent the speech component in the mth microphone pair. Likewise, V_{Lm}(ω) and V_{Rm}(ω) represent the noise component of the mth microphone pair. All received microphone signals are used to design the filters, W_{L}(ω) and W_{R}(ω), and to generate an output for the left and right ear, Z_{L0}(ω) and Z_{R0}(ω). ω indicates the frequency domain variable.

The following definitions will be used in the derivation of the Wiener filter extension. First, we define the 2M dimensional signal vector.

Y(ω)=[Y_{L}_{₀}(ω) . . . Y_{L}_{_{M-1}}(ω)Y_{R}_{₀}(ω) . . . Y_{R}_{_{M-1}}(ω)]^{T} (3)

As generally known, the letter T as used in equation (3) indicates that the vector (or matrix) is transposed.

In a similar fashion we write X(ω) and V(ω), where Y(ω)=X(ω)+V(ω). Next, we define the 2M-dimensional filters for the left and right hearing aid.

W_{L}(ω)=[W_{L}_{₀}(ω) . . . W_{L}_{_{2M-1}}(ω)]^{T} (4)

W_{R}(ω)=[W_{R}_{₀}(ω) . . . W_{R}_{_{2M-1}}(ω)]^{T} (5)

Using (4) and (5), we write the 4M-dimensional stacked filter,

$$W ( ω ) = [ \begin{matrix}{W}_{L} ( ω ) \\ {W}_{R} ( ω )\end{matrix} ] . \qquad ( 6 )$$

The outputs of the left and right Wiener filter are written below.

Z_{L}(ω)=W_{L}^{H}(ω)Y(ω) Z_{R}(ω)=W_{R}^{H}(ω)Y(ω) (7)

As generally known, the letter H as used in equation (7) indicates hermitian transposition.

The outputs of the left and right Wiener filters are the estimates of the speech (or noise) components in the first microphone pair. Nevertheless, the algorithm could be designed to estimate any microphone pair, more precisely, to estimate the speech or noise components in any microphone pair. For clarity, the frequency domain variable, ω, will be omitted throughout the remainder of this application.

### Example II

### Interaural Transfer Function

In this example we define the desired ITFs of the speech and noise components. The cost function in example III will incorporate these desired ITFs. This is, why they are referred to as desired ITFs.

In order to preserve the ITFs of the speech and noise components, we simply have to set the desired ITFs equal to the actual ITFs. Correspondingly, the localization cues, ITD and ILD cues, of the speech and noise components can be preserved.

Alternatively, any pair of desired ITFs can be chosen. Therefore the perceived location of the speech and noise component can be manipulated.

The ITF is the ratio of the signal in the left ear to the signal in the right ear. The input speech and noise ITFs are written below.

$$I T {F}_{{X}_{in}} = \frac{{X}_{{L}_{0}}}{{X}_{{R}_{0}}} \\ I T {F}_{{V}_{in}} = \frac{{V}_{{L}_{0}}}{{V}_{{R}_{0}}} . \qquad ( 8 )$$

Similarly, the ITFs of the output speech and noise components are,

$$I T {F}_{{X}_{out}} ( W ) = \frac{{W}_{L}^{H} X}{{W}_{R}^{H} X} \\ I T {F}_{{V}_{out}} ( W ) = \frac{{W}_{L}^{H} V}{{W}_{R}^{H} V} . \qquad ( 9 )$$

In order to preserve the binaural cues of the speech and noise components, the original ITFs are selected as the desired ITFs. We assume that the original ITFs (8) to be constant¹ and can be estimated, in a least squares sense, using the microphone signals. ¹In the case of a single noise source, this desired noise ITF is equal to the ratio of the acoustic transfer functions between the noise source and the reference microphone signals. In this case, it can also be shown that preserving the ITF is mathematically equivalent to preserving the phase of the cross-correlation, i.e. the ITD, and preserving the power ratio, i.e. the ILD.

$${ITF}_{{X}_{des}} = \frac{ɛ \{ {X}_{{L}_{0}} {X}_{{R}_{0}}^{*} \}}{ɛ \{ {X}_{{R}_{0}} {X}_{{R}_{0}}^{*} \}} \\ {ITF}_{{V}_{des}} = \frac{ɛ \{ {V}_{{L}_{0}} {V}_{{R}_{0}}^{*} \}}{ɛ \{ {V}_{{R}_{0}} {V}_{{R}_{0}}^{*} \}} \qquad ( 10 )$$

As commonly known, the letter ε as used in equation (10) indicates that the expectation value is formed. The index “des” stands for “desired”.

However, any set of HRTFs (head-related transfer functions) can be chosen. Therefore the direction of arrival (more precisely: the apparent direction of arrival) of the speech and noise components can be controlled. For simplicity, the desired ITFs of the speech and noise components are written in function of the desired angles of the speech and noise components, θ_{X} and θ_{V}, and frequency, ω.

$$\begin{matrix}{ITF}_{{X}_{des}} = \frac{{HRTF}_{{X}_{L}} ( ω , {θ}_{X} )}{{HRTF}_{{X}_{R}} ( ω , {θ}_{X} )} & ( 11 ) \\ {ITF}_{{V}_{des}} = \frac{{HRTF}_{{V}_{L}} ( ω , {θ}_{V} )}{{HRTF}_{{V}_{R}} ( ω , {θ}_{V} )} & ( 12 )\end{matrix}$$

HRTF_{XL}(ω;θX) and HRTF_{XR}(ω;θX) are the head-related transfer functions (HRTF) for the speech component of the left and right ear. Similarly, HRTF_{VL}(ω;θV) and HRTF_{VR}(ω;θV) are the HRTFs for the noise component of the left and right ear.

In this paper we will address both situations. First we will look at the performance of the algorithms when trying to preserve the original ITFs. Later the possibility of manipulating the ITFs of the speech and noise components will be explored.

### Example III

### Binaural Multi-Channel Wiener Filtering

In this example we derive the binaural multi-channel Wiener filter that performs noise reduction, while preserving the ITFs of the speech and noise component. We begin by looking at the binaural expansion of the speech distortion weighted cost function discussed in [9]. Using the reasoning from example II the cost function is manipulated to incorporate two terms used to preserve the ITFs of the speech and noise components. The final cost function contains the original speech distortion weighted terms (cf. [9]) plus two additional terms for the ITFs of the speech and noise components.

A. Original Cost Function

The multi-channel Wiener filter generates a minimum mean square error estimate of the speech component in the first microphone pair² [1], [10]. The original binaural cost function is written as, ²However the mth microphone pair can be used.

$$J ( W ) = ɛ \{ {‖ [ \begin{matrix}{X}_{{L}_{0}} - {W}_{L}^{H} Y \\ {X}_{{R}_{0}} - {W}_{R}^{H} Y\end{matrix} ] ‖}^{2} \} . \qquad ( 13 )$$

In [9]-[11] the original cost function is split into two terms. The first term quantifies speech distortion and the second residual noise. Next a weight, μ, is added to initiate a trade-off between speech distortion and noise reduction. Analogously, this reasoning can be applied to the binaural cost function in (13). The binaural speech distortion weighted cost function is expressed below.

$$J ( W ) = ɛ \{ {\underbrace{{‖ [ \begin{matrix}{X}_{{L}_{0}} - {W}_{L}^{H} X \\ {X}_{{R}_{0}} - {W}_{R}^{H} X\end{matrix} ] ‖}^{2}}}_{Speech Distortion} + μ \underbrace{{‖ [ \begin{matrix}{W}_{L}^{H} Y \\ {W}_{R}^{H} Y\end{matrix} ] ‖}^{2}}_{Residual Noise} \} \qquad ( 14 )$$

B. Cost Function Incorporating ITFs

In order to incorporate the ITFs of the speech and noise components, the speech distortion and residual noise vectors are broken into components that are parallel and perpendicular to the desired ITF vector. Seeing that only the direction of the desired ITF vector is important, whether preserving or manipulating the original ITFs, we can write the desired noise ITF vector as,

$$[ \begin{matrix}{V}_{{L}_{0}} \\ {V}_{{R}_{0}}\end{matrix} ] ‖ to [ \begin{matrix}{HRTF}_{{V}_{L}} ( ω , θ ) \\ {HRTF}_{{V}_{R}} ( ω , θ )\end{matrix} ] ‖ to [ \begin{matrix}{ITF}_{{V}_{des}} \\ 1\end{matrix} ] . \qquad ( 15 )$$

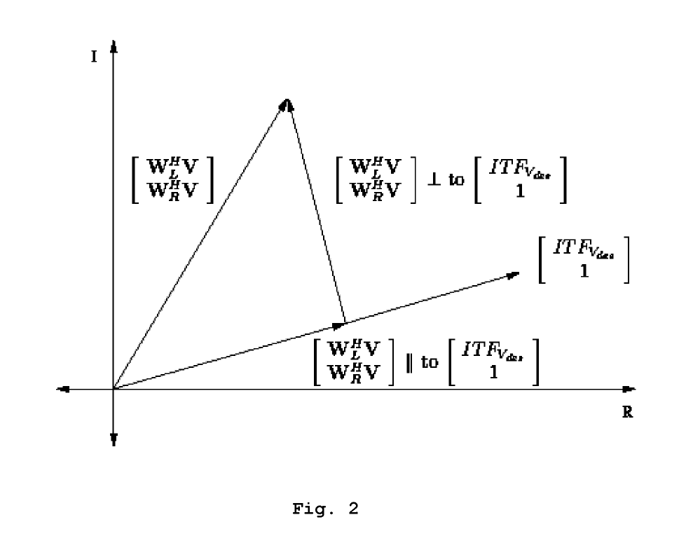

The decomposition of the residual noise vector is depicted in FIG. 2. A similar decomposition can be obtained for the speech distortion vector. Remember that this decomposition is performed for each frequency bin. In order to preserve the desired ITFs of the speech and noise components, the speech distortion and residual noise vectors need to be parallel to the desired ITF vectors.

This can be done by putting a positive weight on the perpendicular terms. Therefore our cost function is now

$$J ( W ) = ɛ \{ \begin{matrix}{\underbrace{{‖ {[ \begin{matrix}{X}_{{L}_{0}} - {W}_{L}^{H} X \\ {X}_{{R}_{0}} - {W}_{R}^{H} X\end{matrix} ]}_{‖} ‖}^{2} + {α}_{x}^{1} {‖ {[ \begin{matrix}{X}_{{L}_{0}} - {W}_{L}^{H} X \\ {X}_{{R}_{0}} - {W}_{R}^{H} X\end{matrix} ]}_{⊥} ‖}^{2}}}_{Speech Distortion} + \\ \underbrace{μ ( {‖ {[ \begin{matrix}{W}_{L}^{H} V \\ {W}_{R}^{H} V\end{matrix} ]}_{‖} ‖}^{2} + {α}_{V}^{1} {‖ {[ \begin{matrix}{W}_{L}^{H} V \\ {W}_{R}^{H} V\end{matrix} ]}_{⊥} ‖}^{2} )}_{Residual Noise}\end{matrix} \} . \qquad ( 16 )$$

The speech distortion terms in (16) can be rewritten as

$${‖ [ \begin{matrix}{X}_{{L}_{0}} - {W}_{L}^{H} X \\ {X}_{{R}_{0}} - {W}_{R}^{H} X\end{matrix} ] ‖}^{2} + ( {α}_{X}^{1} - 1 ) {‖ {[ \begin{matrix}{X}_{{L}_{0}} - {W}_{L}^{H} X \\ {X}_{{R}_{0}} - {W}_{R}^{H} X\end{matrix} ]}_{⊥} ‖}^{2} \qquad ( 17 )$$

A similar step can be taken for the residual noise vector.

$$\begin{matrix} μ ( {‖ [ \begin{matrix}{W}_{L}^{H} V \\ {W}_{R}^{H} V\end{matrix} ] ‖}^{2} + {α}_{V}^{1} - 1 {‖ {[ \begin{matrix}{W}_{L}^{H} V \\ {W}_{R}^{H} V\end{matrix} ]}_{⊥} ‖}^{2} ) . & ( 19 ) \\ J ( W ) = ɛ \{ \begin{matrix}\begin{matrix}{‖ [ \begin{matrix}{X}_{{L}_{0}} - {W}_{L}^{H} X \\ {X}_{{R}_{0}} - {W}_{R}^{H} X\end{matrix} ] ‖}^{2} + μ {‖ [ \begin{matrix}{W}_{L}^{H} V \\ {W}_{R}^{H} V\end{matrix} ] ‖}^{2} ++ \\ α \frac{{\vert {W}_{L}^{H} X - {ITF}_{{X}_{des}} {W}_{R}^{H} X \vert}^{2}}{{‖ [ \begin{matrix}{ITF}_{{X}_{des}} \\ 1\end{matrix} ] ‖}^{2}} +\end{matrix} \\ β \frac{{\vert {W}_{L}^{H} V - {ITF}_{{V}_{des}} {W}_{R}^{H} V \vert}^{2}}{{‖ [ \begin{matrix}{ITF}_{{V}_{des}} \\ 1\end{matrix} ] ‖}^{2}}\end{matrix} \} . & ( 18 )\end{matrix}$$

Furthermore,

$$‖ {[ \begin{matrix}{X}_{{L}_{0}} - {W}_{L}^{H} X \\ {X}_{{R}_{0}} - {W}_{R}^{H} X\end{matrix} ]}_{⊥} ‖ = ‖ {[ \begin{matrix}{W}_{L}^{H} X \\ {W}_{R}^{H} X\end{matrix} ]}_{⊥} ‖ \qquad ( 20 )$$

for both vectors perpendicular to

$$[ \begin{matrix}{ITF}_{{X}_{des}} \\ 1\end{matrix} ] .$$

Armed with (17), (19), and (20) and defining new weights, α and β, the cost function, consisting of a speech distortion term, a residual noise term and two ITF terms, is

$$J ( W ) = ɛ \{ \begin{matrix}\underbrace{{‖ [ \begin{matrix}{X}_{{L}_{0}} - {W}_{L}^{H} X \\ {X}_{{R}_{0}} - {W}_{R}^{H} X\end{matrix} ] ‖}^{2} + μ {‖ [ \begin{matrix}{W}_{L}^{H} V \\ {W}_{R}^{H} V\end{matrix} ] ‖}^{2}}_{Original SDW Cost Function} + \\ \underbrace{α {‖ {[ \begin{matrix}{W}_{L}^{H} X \\ {W}_{R}^{H} X\end{matrix} ]}_{⊥} ‖}^{2} + β {‖ {[ \begin{matrix}{W}_{L}^{H} V \\ {W}_{R}^{H} V\end{matrix} ]}_{⊥} ‖}^{2}}_{Additional ITF Terms}\end{matrix} \} . \qquad ( 21 )$$

Using the definition of the cross product, (21) can be written as (18). Next, we take the derivative of (18), set the derivative to zero, and solve for W. Since J(W) is the cost function, the optimum solution for W, i.e., the optimum filter, can be found as a zero of its derivative. The solution, i.e., the optimum filter, is expressed in matrix form below.

$$W = {( ɛ \{ {R}_{{R}_{X}} + μ {R}_{{R}_{V}} + α {R}_{{R}_{XC}} β {R}_{{R}_{VC}} \} )}^{- 1} ɛ \{ {r}_{X} \} , \\ where , \\ {r}_{x} = [ \begin{matrix}{X}_{{L}_{0}}^{*} X \\ {X}_{{R}_{0}}^{*} X\end{matrix} ] \begin{matrix}{R}_{X} = {XX}^{H} \\ {R}_{V} = {VV}^{H}\end{matrix}$$

$${R}_{{R}_{X}} = [ \begin{matrix}{R}_{X} & {0}_{2 M} \\ {0}_{2 M} & {R}_{X}\end{matrix} ] {R}_{{R}_{V}} = [ \begin{matrix}{R}_{V} & {0}_{2 M} \\ {0}_{2 M} & {R}_{V}\end{matrix} ]$$

$${R}_{{R}_{XC}} = \frac{[ \begin{matrix}{R}_{X} & - {ITF}_{{X}_{des}}^{*} {R}_{X} \\ - {ITF}_{{X}_{des}} {R}_{X} & {\vert {ITF}_{{X}_{des}} \vert}^{2} {R}_{X}\end{matrix} ]}{{‖ \begin{matrix}{ITF}_{{X}_{des}} \\ 1\end{matrix} ‖}^{2}}$$

$${R}_{{R}_{VC}} = \frac{[ \begin{matrix}{R}_{V} & - {ITF}_{{V}_{des}}^{*} {R}_{V} \\ - {ITF}_{{V}_{des}} {R}_{V} & {\vert {ITF}_{{V}_{des}} \vert}^{2} {R}_{V}\end{matrix} ]}{{‖ \begin{matrix}{ITF}_{{V}_{des}} \\ 1\end{matrix} ‖}^{2}}$$

This notation allows us to gain some crucial insight into the filter design. Clearly, if there is no correlation between the signals at the right and left ear, the filter design is decoupled. This is logical since there are no cues to preserve. Additionally, if α and β are chosen to be zero, then the left and right filter design becomes independent. And the filters are those from the original binaural speech distortion weighted cost function in (14).

### Example IV

### Simulations

A. Experimental Setup

Two sets of simulations were run. The first set of simulations attempted to show the algorithm's ability to preserve the original ITFs of the speech and noise components. The second set of simulations showed how altering the algorithm's desired ITFs can shift the perceived location of the noise source.

The recordings used in the simulations were made in a reverberant room, T60=0:76 sec. Two behind the ear (BTE) hearing aids were placed on a CORTEX MK2 artificial head. Each hearing aid had two omni-directional microphones. The sound level measured at the center of the dummy head was 70 dB SPL. Speech and noise sources were recorded separately. All recordings were performed at a sampling frequency of 16 kHz. HINT sentences and HINT noise were used for the speech and noise signals [12].

In the simulations both microphone signals from each hearing aid were used, M=2, to estimate the speech component in the first microphone pair. The statistics were calculated offline, and access to a perfect voice activity detection (VAD) algorithm was assumed. An FFT length of 256 was used.

For the first set of simulations the speech source was located in front of the artificial head, 0°, and the noise source was located at 45°. The parameter controlling the ITF of the speech component, α, was varied from 0 to 10 and the parameter controlling the ITF of the noise component, β, was varied from 0 to 100. The parameter governing noise reduction, μ, was held constant at 1.

The same setup was used for the second set of simulations. However, this time the desired noise ITF was not the least squares estimate of the actual noise ITF, but the ITF for a source located at 225°. This ITF was calculated using the HRTFs for a source located at 225°. Again, α, was varied from 0 to 10 and β was varied from 0 to 100. The noise reduction parameter, μ, was held constant at 1.

B. Performance Measures

The purpose of the simulations is to show the effect of the parameters on ITD error, ILD error, SNR improvement, and ITF error. The ITD metric, written below, is the average over frequency bins of the absolute difference between the cosine of the phase of the input cross-correlation and the cosine of the phase of the output cross-correlation.

$$ITD Error = \frac{1}{N} {\sum }_{i = 1}^{N} \vert \begin{matrix}cos ( ɛ \{ {X}_{{L}_{0}} ( {ω}_{i} ) {X}_{{R}_{0}}^{*} ( {ω}_{i} ) \} ) - \\ cos ( ɛ \{ {X}_{{L}_{0}} ( {ω}_{i} ) {X}_{{R}_{0}}^{*} ( {ω}_{i} ) \} )\end{matrix} \vert$$

The second measure, expressed below, assessed the preservation of the ILD cues. The average over frequency bins of the absolute difference of the ILD of the input signals and ILD of the output signals is used.

$$ILD Error = \frac{1}{N} {\sum }_{i = 1}^{N} \vert 10 {log}_{10} \frac{{P}_{{L}_{in}} ( {ω}_{i} )}{{P}_{{R}_{in}} ( {ω}_{i} )} - 10 {log}_{10} \frac{{P}_{{L}_{out}} ( {ω}_{i} )}{{P}_{{R}_{out}} ( {ω}_{i} )} \vert$$

P stands for power and ILD error is averaged over the N frequency bins. The ITF error corresponds to the ITF terms of the speech and noise component in the cost function,

W^{H}R_{R}_{_{XC}}W and W^{H}R_{R}_{_{VC}}W

In order to quantify the noise reduction performance, the speech intelligibility weighted signal-to-noise-ratio, defined in [13], is used.

$${SNR}_{INT} = {\sum }_{j = 1}^{J} {w}_{j} {SNR}_{j}$$

The weight, wⱼ, emphasizes the importance of the jth ⅓-octave frequency band's overall contribution to intelligibility, and SNRj is the signal-to-noise-ratio of the jth ⅓-octave frequency band. The band definitions and the individual weights of the J frequency bands are given in [14].

C. Results and Discussion

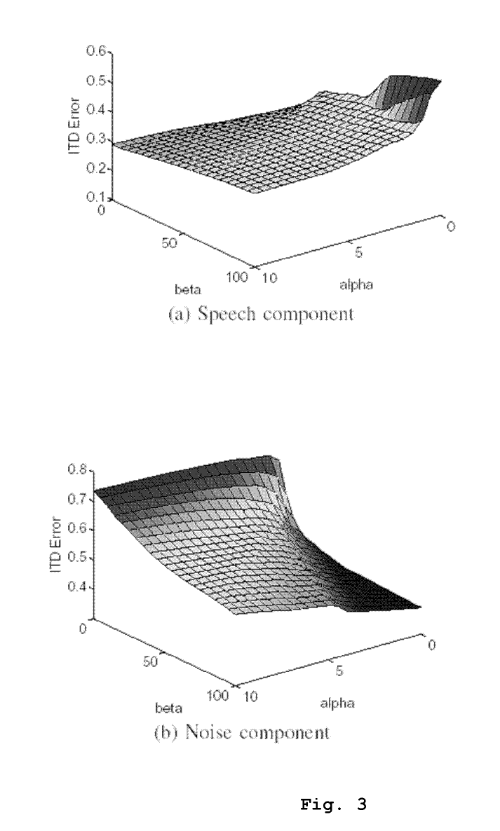

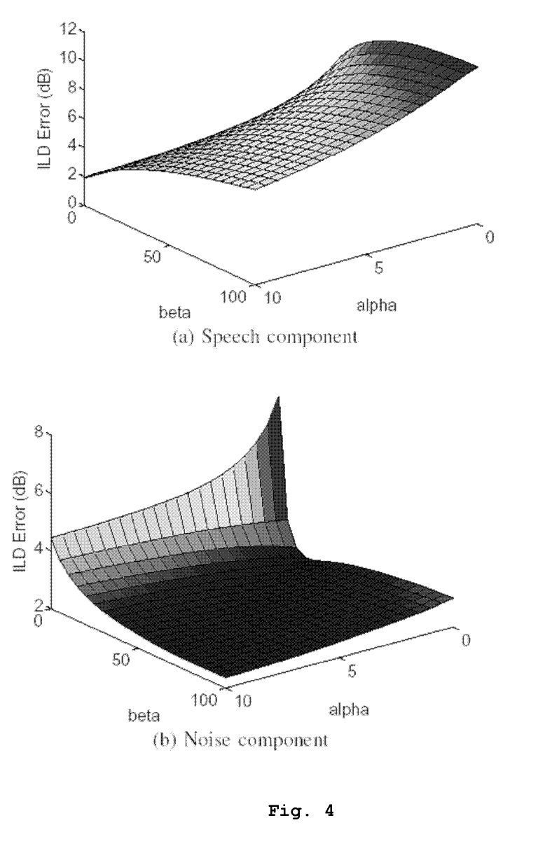

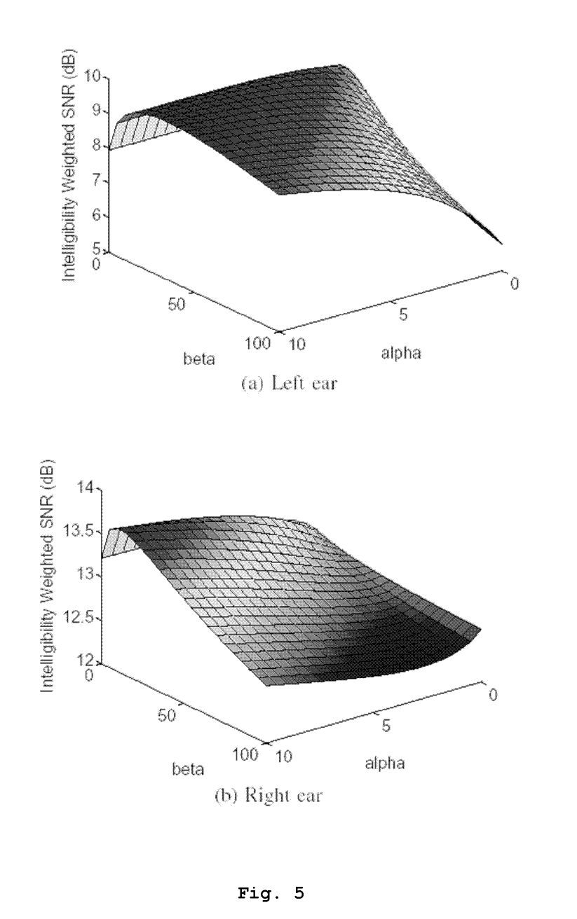

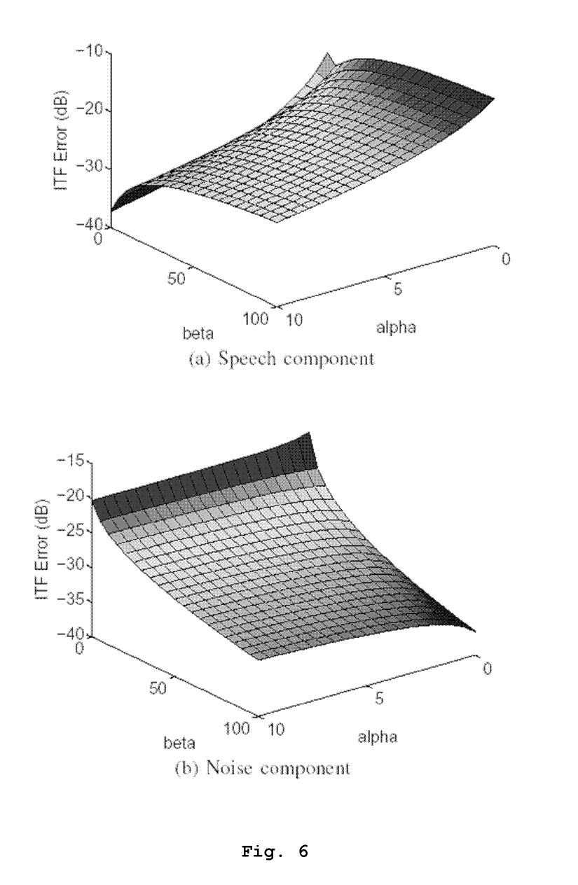

The first set of simulations attempted to show the algorithm's ability to preserve the original ITFs of the speech and noise components. FIG. 3 shows the ITD error for the speech and noise component. The ILD error is depicted in FIG. 4. The improvement in speech intelligibility weighted SNR can be seen in FIG. 5. Finally, FIG. 6 illustrates the ITF error for the speech and noise component.

One should begin by looking at the ITF error of the speech and noise component. Clearly, it can be seen from FIG. 6(a) that the ITF error of the speech component decreases as α increases. Corresponding, the cost function is decreasing. However, increasing the parameter β, attempting to preserve the ITF of the noise component, causes the ITF error of the speech component to increase. Similarly, the ITF error of the noise component decreases as β increases, this behaviour is expected. Again, the other parameter, α, has a negative influence on the ITF error. Clearly, there is a trade off between preserving the ITF of the speech and noise component. These influences also arise with other performance metrics. Now we turn our attention to the ITD cues of the speech components in FIG. 3(a). First, it is important to notice that the speech ITD cues are preserved for the original binaural multi-channel Wiener filtering scheme, α=0 and β=0, proposed in [1]. Moreover, the speech ITD cues are preserved for almost all combinations of α and β. They are only distorted when β is large, but this can be controlled by increasing α.

In FIG. 3(b), clearly the ITD cues of the noise component are distorted for the original binaural multi channel Wiener filtering approach. Increasing the parameter β leads to the preservation of the noise ITD cues. However, the preservation of the noise ITD cues is dependent on α. A small increase in α can cause the noise ITD cues to be distorted. Nevertheless, certain combinations of α and β exist where the ITD cues of the noise component are preserved.

Looking at the ILD error of the speech component, depicted in FIG. 4(a), we again see that the ILD cues of the speech component are well preserved for the original binaural multichannel Wiener filtering algorithm. A small amount of distortion is visible when β is increased. The influence of α is minimal when β is above zero.

On the other hand, the ILD cues of the noise component are clearly distorted when α and β are both zero. As β is increased, the ILD error of the noise component decreases. The parameter α has little influence on the ILD error of the noise component for β>0. Again a combination of α and β can be found that preserve the ILD cues of the speech and noise components.

Finally, the improvement in speech intelligibility weighted SNR for the left and right ear is shown in FIG. 5.

Clearly, regardless of the values of α and β this algorithm performs good noise reduction.

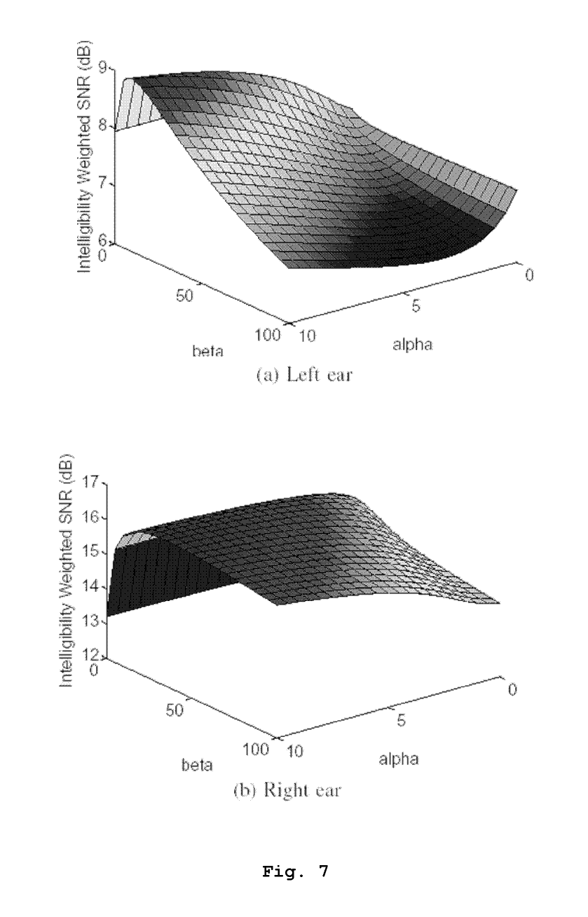

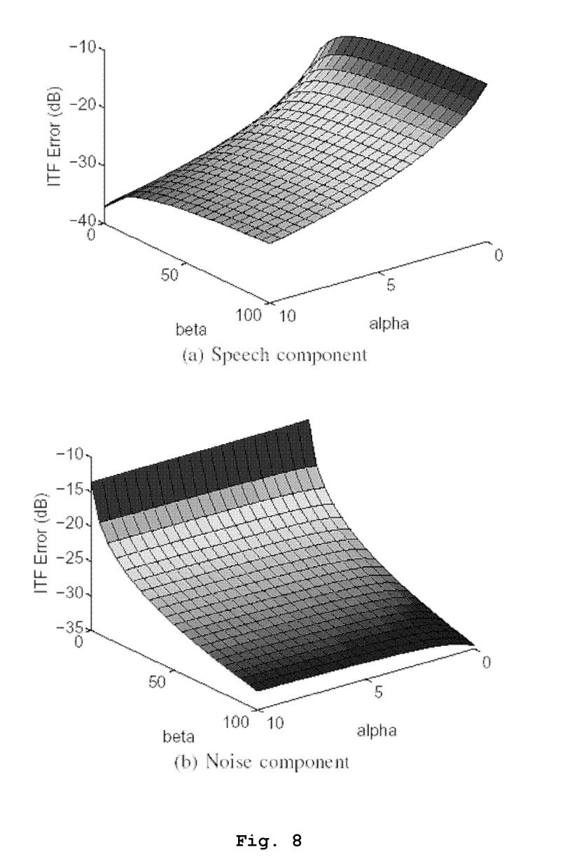

Varying α and β causes some fluctuation in noise reduction performance, but the overall performance remains good. The second set of simulations is designed to show how altering the algorithm's desired ITFs can shift the perceived location of a source. In this case we focus on shifting the noise source from its original location at 45° to a new location at 225°. The main performance measure we will use is the value of the ITF terms from the cost function. The ITF error is plotted in FIG. 8, and the improvement in speech intelligibility weighted SNR is depicted in FIG. 7.

FIG. 8 shows that the noise component can be shifted from a location of 45° to a perceived location of 225°, while preserving the ITF of the speech source. Again, as β is increased, the ITF error decreases.

Additionally, by looking at FIG. 7 it is clear that even while altering the perceived location of the noise source, good noise reduction performance can be achieved.

Clearly, we have shown that for the correct choice of parameters it is possible to preserve the current acoustical situation. It is even possible to alter the current acoustical situation to a more favourable one by moving noise sources. A further aspect of present invention is the automatical selection of the parameters in function of the current acoustical situation. Yet another aspect of present invention is to choose α, β, and μ to be frequency dependent. These parameters can be chosen in function of the speech and noise power in each frequency bin. It does not make sense to try to preserve the ITF of a component in a frequency bin where that component is not present. Conversely, it would be beneficial to make sure the ITF of the component is preserved when a frequency bin contains a large amount of that component. This will lead to better preservation of the localization cues and help reduce the interdependencies among the parameters.

### Further Embodiments

After the more mathematically and algorithmically oriented aspects of the invention have now been described in great detail, in the following, some embodiments are described in conjunction with block-diagrammatical figures.

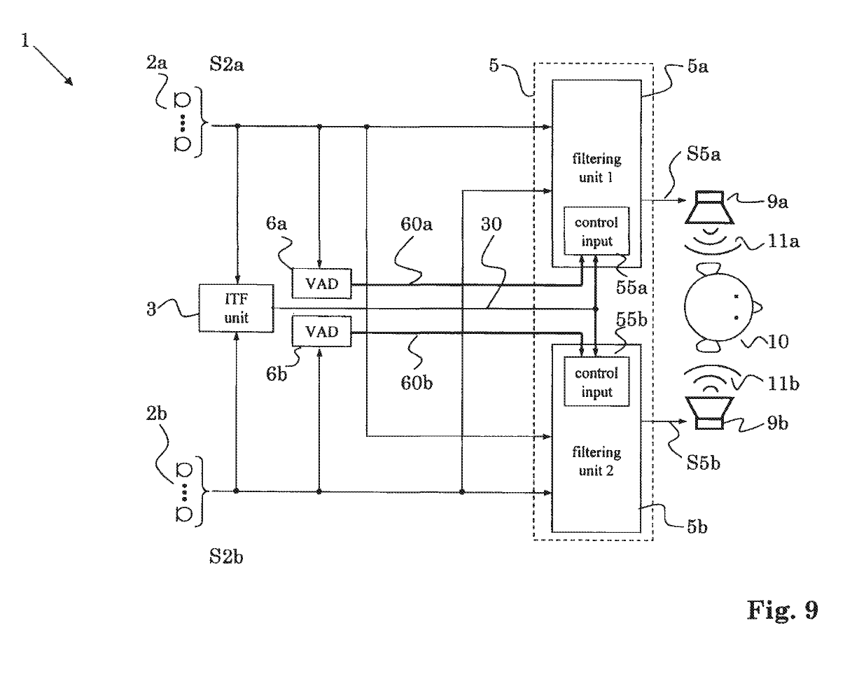

FIG. 9 shows a block-diagrammatical illustration of an embodiment with voice activity detection. The binaural hearing system 1 comprises two input transducer units 2a,2b, an ITF unit 3, two voice activity detectors 6a,6b, a noise reduction means 5 comprising two filtering units 5a,5b, and two output transducer units 9a,9b.

Input transducer units 2a,2b receive sound (in form of sound waves), and convert it into audio signals S2a,S2b, which are fed to both filtering units 5a,5b in order to be filtered, so as to reduce noise components and achieve an improved intelligibility.

ITF unit 3 also receives audio signals from input transducer units 2a and 2b and obtains therefrom at least one interaural transfer function 30 (more precisely: data representative of at least one interaural transfer function), which is fed to control inputs 55a and 55b of filtering units 5a and 5b, respectively.

Detecting unit 6a,6b, which are, e.g., embodied as voice activity detectors 6a,6b, also receive audio signals from input transducer units 2a and 2b each, and obtain therefrom voice activity signals 60a and 60b, respectively. These signals are fed to control inputs 55a and 55b of filtering units 5a and 5b, respectively.

The optimization functions of filtering units 5a,5b are identical (have the same form), comprising at least one term representing a desired interaural transfer function for wanted signals and at least one term describing a desired interaural transfer function for unwanted signals. Values to be assigned to said terms are received at said control inputs 55a and 55b, respectively.

Accordingly, filtering coefficients of filtering units 5a,5b depend on data received at said control inputs 55a,55b, respectively. If voice activity signals 60a and 60b, respectively, indicate that speech signals, i.e. wanted signals, are currently prevailing, the ITF 30 will be interpreted by filtering units 5a and 5b, respectively, as an ITF of wanted signal components. Accordingly, in the calculation of the filtering coefficients in the filtering units 5a and 5b, newly obtained values will be assigned to terms representing the desired ITF for wanted signal components.

On the other hand, if voice activity signals 60a and 60b, respectively, indicate that noise signals, i.e. unwanted signals, are currently prevailing, the ITF 30 will be interpreted by filtering units 5a and 5b, respectively, as an ITF of unwanted signal components (noise). Accordingly, in the calculation of the filtering coefficients in the filtering units 5a and 5b, newly obtained values will be assigned to terms representing the desired ITF for unwanted signal components.

This allows to generate noise-filtered audio signals S5a,S5b, in which noise is reduced, while the ITF is preserved, for both, wanted and unwanted signal components, so as to preserve binaural cues.

These signals S5a,S5b are converted by loudspeakers 9a and 9b, repsectively, into signals 11a,11b to be perceived by a user 10 of said binaural hearing system 1.

Of course, it is also possible to provide only one voice activity detector instead of two, in which case the control signal produced by this one voice activity detector would be fed to both control inputs 55a,55b.

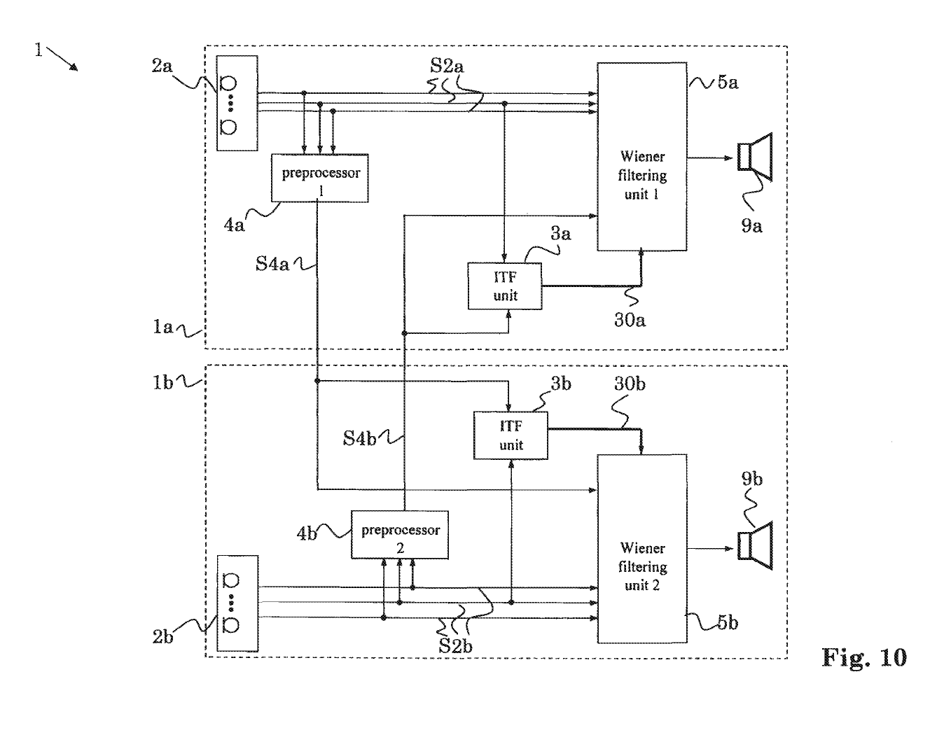

In the following FIGS. 10 to 12, detecting units such as voice activity detectors are not shown.

Said audio signals S2a and S2b can comprise more than one audio signal stream, in particular if the input transducer units 2a,2b comprise more than one input transducer each.

The functional units shown in FIG. 9 can be distributed over two or more devices of the binaural hearing system 1 in many ways. And some units can be realized two times, or only once, wherein in the latter case, it may be necessary to transmit data (control data and/or audio signals) from one device to the other, wherein it is to be noted that the bandwith for such transmissions is usually quite limited, and the less data need to be transmitted, the smaller is the power consumption therefor, which is particularly important when a hearing device has to transmit data.

The following FIGS. 10 to 12 show embodiments, which are related to the embodiment shown in FIG. 9, but emphasize the before-mentioned points of distributing functionalities among devices of the hearing system 1 and the point of minimizing the required transmission bandwidth.

FIG. 10 is a block-diagrammatical illustration of an embodiment with preprocessors 4a,4b and two ITF units 3a,3b. In addition, one line per audio signal stream is drawn, wherein, there could be also be two or four or more audio signal streams generated by each input transducer unit 2a,2b. Said preprocessors 4a,4b basically make sense only with at least two input transducers per input transducer unit.

In order to optimize the use of bandwidth available for data transmission between the hearing devices 2a and 2b, the transmitted audio signals should be particularly useful audio signals. An unprocessed output of an input transducer is usually not as valuable as a signal obtained by combining signals of two or more input transducers.

In order to generate particularly useful audio signals, said preprocessors 4a,4b are used. Such a preprocessor 4a,4b has a reduced number of output audio signal streams with respect to input audio signal streams, in particular, from two or more input audio signal stream, one single output audio signal stream is obtained, referred to as preprocessed audio signals S4a, S4b. Such a preprocessor 4a,4b can implement, e.g., a beamformer or a compression algorithm.

There is also one other way of optimizing the use of the available bandwidth shown in FIG. 10. Both said ITF units 3a,4a, each one of which is comprised in one of hearing devices 1a and 1b, receive audio signals derived from said first input transducer unit 2a and audio signals derived from said second input transducer unit 2b. Although with respect to quality of the obtained ITF data 30a,30b usually not preferred, it is possible, as shown in FIG. 10, to use said preprocessed audio signals S4a and S4b as inputs to the ITF units 3b and 3a, respectively, instead of using separately transmitted audio signals that are not preprocessed.

The second input of ITF units 3a,3b is fed with un-preprocessed audio signals from the input transducer unit 2a,2b comprised in the same hearing device 1a,1b as the corresponding ITF unit 3a,3b. It is possible to use preprocessed audio signals S4a,S4b instead.

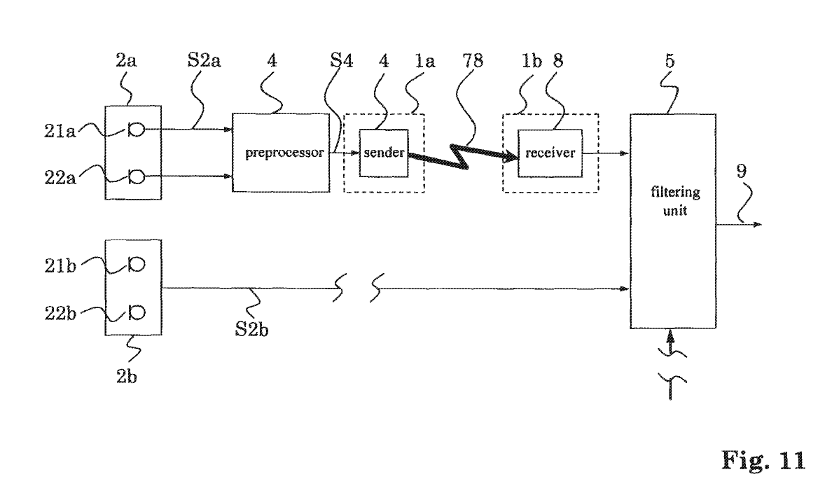

FIG. 11 is a block-diagrammatical illustration of a detail of an embodiment with preprocessing and wireless transmission. In conjunction with the transmission of data between different devices of the binaural hearing system 1 and also in conjunction with preprocessing of audio data, FIG. 11 shall remind of the various possibilities of arranging different functional units within said different devices.

In conjunction with the transmission, in particular wireless transmission, of data between different devices of the binaural hearing system, it is actually only necessary to comprise a sender 7 in one device 1a, and a receiver 8 in another device 1b. The other functional units may be comprised in the same or in other devices. E.g., communication from one hearing device to the other hearing device may, in part, take place indirectly, via a third device. Such a third device may, e.g., be worn at a necklace. A third device may be much less restricted with respect to energy consumption and/or to transmission intensity and/or bandwidth. Such a third device may furthermore provide processing power, e.g., for implementing signal processing, e.g., for preprocessing and/or filtering.

It is to be noted that also remote microphones can be an input transducer unit or be comprised therein. As input audio signals for ITF units, nevertheless, it is usually strongly preferred to use audio signals from input transducers located in or near the left and right ear, respectively, of a user. But for the noise reduction aspect, remote microphones can be very useful.

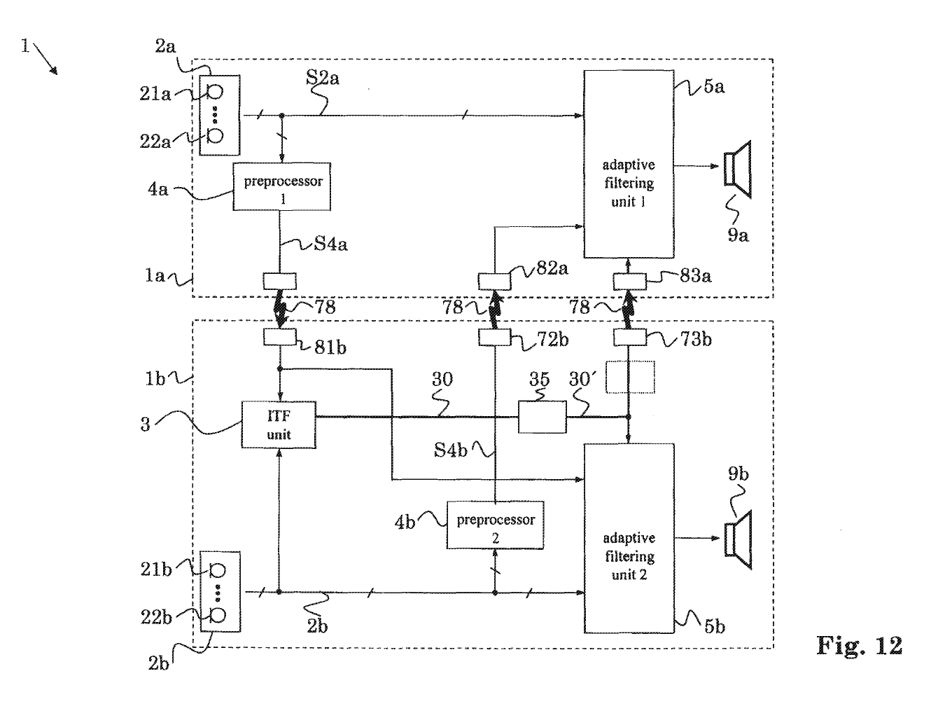

FIG. 12 is a block-diagrammatical illustration of an embodiment with preprocessors 4a,4b and one ITF unit 3. Sending and receiving units are explicitely shown. Furthermore, slashed lines indicate one or more audio data streams.

Since only one ITF unit 3 is provided, the ITF data 30 have to be transmitted from hearing device 1b to hearing device 1a. The amount of data per time of the ITF data 30 is in principle the same as the amount of data per time of one audio signal stream. But the ITF usually will not change very fast, since sound sources usually do not move very fast. Therefore, it is possible to save data transmission bandwidth by transmitting not the full ITF data as obtainable from the audio signals; e.g. by transmitting only a portion of said full ITF data. In FIG. 12, this is symbolized by a data reducing unit 35, which obtains a data-reduced form 30′ of the ITF data from ITF data 30.

E.g., it is possible to compress the ITF data 30. It is also possible to transmit data related to the ITF only when the ITF changes more than by a prescribed amount. It is also possible to use a smaller sampling rate for said data-reduced form 30′ and/or to use a smaller resolution therefor, e.g., by a smaller bit depth.

Instead of providing both filtering units 5a,5b with said data-reduced form 30′ of the ITF, it is possible to arrange data reducing unit 35 in the location indicated by the dotted rectangular in FIG. 12 and provide filtering unit 5b still with the full ITF data 30.

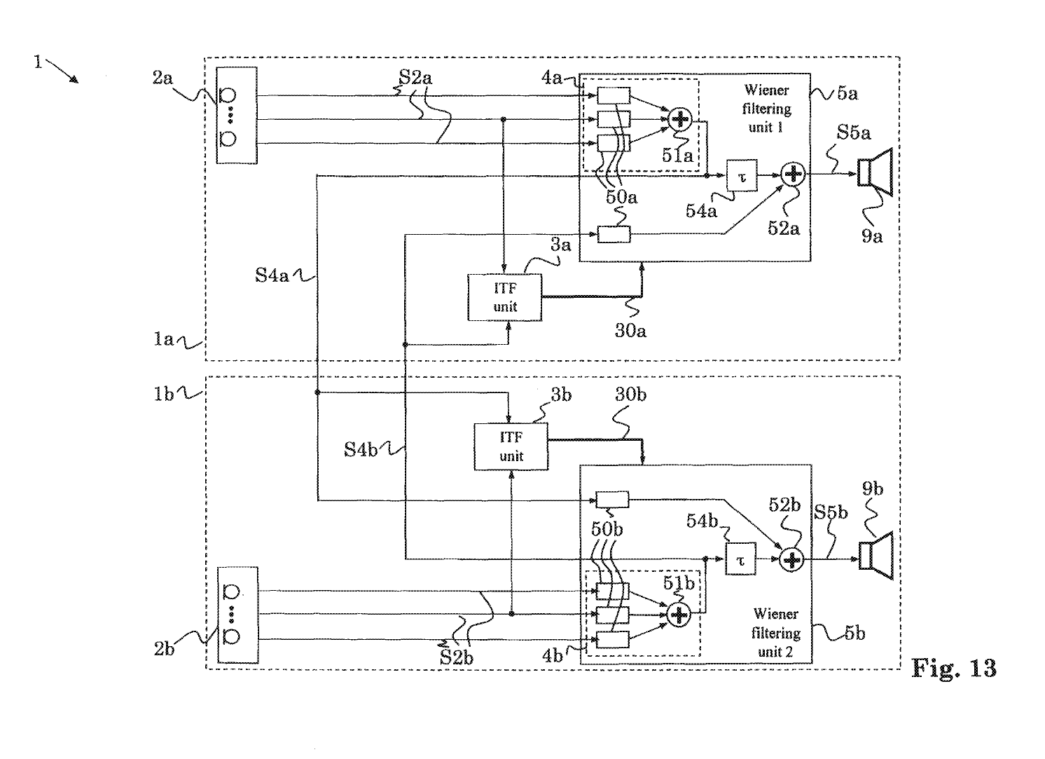

FIG. 13 shows a block-diagrammatical illustration of an embodiment with preprocessors 4a,4b comprised in filtering units 5a,5b, respectively. The embodiment of FIG. 13 is similar to that of FIG. 10 and will be described mainly with respect to the differences thereto. The embodiment of FIG. 13 takes advantage of the fact that intermediate results obtained in filtering units 5a,5b (be it Wiener filtering units or others) can be used as preprocessed audio signals S4a,S4b or used for deriving preprocessed audio signals S4a,S4b.

Accordingly, instead of having preprocessing units 4a,4b separate from filtering units 5a,5b, the preprocessing units 4a,4b are quasi comprised in filtering units 5a and 5b, respectively.

Just like in the other embodiments and as shown in FIG. 13, too, the filtering units 4a,4b typically are largely identically construed. Therefore, only filtering unit 5a will be described.

Typically, as shown in FIG. 13, each audio signal stream S2a and also audio signal stream S4b is filtered by itself (separate filtering of input audio signals). This is also apparent from the equations in the Examples earlier in the Detailed Description of the Invention. So-obtained audio signals are intermediate results of said filtering unit 5a. Note, that the optimization function is identical for each of the inputted audio signals, whereas their filtering coefficients are usually different, since said input audio signals S2a,S4b are not identical.

Said separate filtering is indicated in FIG. 13 by filtering sub-units 50a. In order to obtain the noise-filtered audio signals S5a, said audio signals obtained by said filtering sub-units 50a are summed up, wherein some further processing may take place before that, in particular, e.g., a weighting of said audio signals. In order to account for time shifts between signals from within the device 1a and signals that have to be transmitted to device 1a before the filtering, a delay unit 54 is provided. In order to achieve a suffient synchronicity upon adding (in summing unit 52a), the audio signals obtained by filtering audio signals S2a in filtering sub-units 50a are delayed with respect to the audio signals obtained by filtering audio signals S4a in filtering sub-units 50a before being summed up in summing unit 52a. In summing unit 52a, some further processing may take place, in particular, e.g., a weighting of said audio signals.

Instead of first adding up said audio signal streams obtained by filtering audio signal streams S2a in filtering sub-units 50a in summing unit 51a and then delaying the resulting audio signals in delay unit 54a, it is also possible to first delay each of said audio signal streams obtained by filtering audio signal streams S2a in filtering sub-units 50a and then summing up the delayed audio signal streams. The latter variant, however, is not shown in FIG. 13 and lacks an advantage of the first-mentioned variant.

Said first-mentioned variant has the advantage, that the audio signals outputted by summing unit 51a can, even without further processing, be used as preprocessed audio signals S4a to be transmitted to device 1b.

Since, after said filtering in sub-units 50a,50b, basically only an adding of audio signals takes place in filtering units 5a,5b before obtaining audio signals S5a,S5b, the particular way of preprocessing according to the embodiment of FIG. 13 or—viewed from a different point of view—this particular selection of audio signals S4a,S4b to be transmitted to the respective other device 1b,1a, has great advantages. The resulting filtered audio signals S5a,S5b come close to the filtered audio signals S5a,S5b that would result in transmitting all audio signals S2a and S2b to the respective other device 1b,1a. The results are usually not identical, because the filtering coefficients depend on the input audio signals, but the input signals are rather similar, since the are usually picked up by means of closely-spaced input transducers.

Accordingly, this embodiment provides—with respect to embodiments with preprocessors 4a,4b separate from filtering units 5a,5b carrying out separate calculations—an enhanced noise reduction at practically no computing cost, and—with respect to an embodiment, in which all audio signals S2a,S2b are transmitted to the respective other device—a reduced amount of data to be transmitted at nearly the same noise reduction performance.

It is, as shown in FIG. 13, possible to use the so-obtained preprocessed audio signals 4a,4b as input signals to the ITF unit 3a. Nevertheless, it would also be possible to use other audio signals as input signals to the ITF unit 3a, in particular substantially un-processed audio signals such as one stream of the audio signal streams S2a for ITF unit 3b and one stream of the audio signal streams S2b for ITF unit 3a, wherein these would have to be transmitted to the respective other device, first.

In embodiments as described with respect to FIG. 13, it is possible to use at least one audio signal stream obtained by filtering and adding up at least two audio signal streams S2a in a first filtering unit 5a as input audio signals to a second filtering unit 5b.

It is to be noted that in an embodiment as shown in FIG. 13, it is even possible to omit those filtering sub-units 50a,50b, to which audio signals S4b,S4a received from the respective other device are inputted, because of the excellent preprocessing these signals have undergone on the respective other filtering unit 5b,5a of the respective other device.

In a particular view onto the invention, the present invention concerns an improvement of the binaural multi-channel Wiener filtering based noise reduction algorithm. The goal of this extension is to preserve both the interaural time delay (ITD) and interaural level difference (ILD) of the speech and noise components. This is done by extending the underlying cost function to incorporate terms for the interaural transfer functions (ITF) of the speech and noise components. Using weights, the emphasis on the preservation of the ITFs can be controlled in addition to the emphasis on noise reduction. Adapting these parameters allows one to preserve the ITFs of the speech and noise component, and therefore ITD and ILD cues, while enhancing the signal-to-noise ratio. Additionally, the desired ITFs can be replaced by known ITFs for a specific direction of arrival. Preserving these desired ITFs allows one to change the direction of arrival of the speech and noise sources.

### REFERENCES CITED

Note: Several documents are cited throughout the text of this specification. Each of the documents herein (including any manufacturer's specifications, instructions etc.) are hereby incorporated by reference; however, there is no admission that any document cited is indeed prior art of the present invention.

[1] T. Klasen, T. Van den Bogaert, M. Moonen, and J. Wouters, “Binaural noise reduction algorithms for hearing aids that preserve interaural time delay cues,” IEEE Trans. on Sig. Proc., vol. 55, no. 4, April 2007.

[2] T. Van den Bogaert, T. Klasen, L. Van Deun, J.Wouters, and M. Moonen, “Horizontal localization with bilateral hearing aids: without is better than with,” J. Acoust. Soc. Amer., col. 119, no. 1, January 2006.

[3] J. Desloge, W. Rabinowitz, and P. Zurek, “Microphone-Array Hearing Aids with Binaural Output-Part I: Fixed-Processing Systems,” IEEE Trans. Speech Audio Processing, vol. 5, no. 6, pp. 529-542, November 1997.

[4] N. Erber, “Auditory-visual perception of speech,” J. Speech Hearing Dis., vol. 40, pp. 481-492, 1975.

[5] M. L. Hawley, R. Y. Litovsky, and J. F. Culling, “The benefit of binaural hearing in a cocktail party: Effect of location and type of interferer,” J. Acoust. Soc. Amer., vol. 115, no. 2, pp. 833-843, February 2004.

[6] J. Peissig and B. Kollmeier, “Directivity of binaural noise reduction in spatial multiple noise-source arrangements for normal and impaired listeners,” J. Acoust. Soc. Amer., vol. 101, no. 3, pp. 1660-1670, 1997.

[7] W. Hartmann, “How We Localize Sound,” Physics Today, pp. 24-29, November 1999.

[8] S. Doclo, R. Dong, T. Klasen, J. Wouters, S. Haykin, and M. Moonen, “Extension of the multi-channel Wiener filter with ITD and ILD cues for noise reduction in binaural hearing aids,” in Proc. IWAENC, Eindhoven, The Netherlands, September 2005.

[9] A. Spriet, M. Moonen, and J. Wouters, “Spatially pre-processed speech distortion weighted multi-channel Wiener filtering for noise reduction,” Signal Processing, vol. 84, no. 12, pp. 2367-2387, December 2004.

[10] S. Doclo and M. Moonen, “GSVD-Based Optimal Filtering for Single and Multi-Microphone Speech Enhancement,” IEEE Trans. Signal Processing, vol. 50, no. 9, pp. 2230-2244, September 2002.

[11] S. Doclo, A. Spriet, J. Wouters, and M. Moonen, Speech Enhancement. Springer-Verlag, 2005, ch. Speech Distortion Weighted Multichannel Wiener Filtering Techniques for Noise Reduction, pp. 199-228.

[12] M. Nilsson, S. Soli, and J. Sullivan, “Development of the hearing in noise test for the measurement of speech reception thresholds in quiet and in noise,” J. Acoust. Soc. Amer., vol. 95, pp. 1085-1096, 1994.

[13] J. Greenberg, P. Peterson, and Z. P. M., “Intelligibility-weighted measures of speech-to-interference ratio and speech system performance,” J. Acoust. Soc. Amer., vol. 94, no. 5, pp. 3009-3010, November 1993.

[14] Acoustical Society of America, “American National Standard Methods for Calculation of the Speech Intelligibility Index,” in ANSI S3.5-1997, 1997.

### LIST OF REFERENCE SYMBOLS

1 hearing system, binaural hearing system

1a device, hearing device, hearing-aid device

1b device, hearing device, hearing-aid device

2a input transducer unit

2b input transducer unit

21a,21b,22a,22b input transducer

3 ITF means, ITF unit

3a,3b ITF unit

30,30a,30b ITF, data representative of interaural transfer function

30′ data-reduced ITF

35 data reducing unit

4,4a,4b preprocessing unit, preprocessor

5 noise reduction means

5a,5b filtering unit, adaptive filter, Wiener filter

50a,50b filtering sub-unit

51a,51b summing unit

52a,52b summing unit

54a,54b delay unit

55a,55b control input

6a,6b detecting unit, voice activity detector

60a,60b control signal, indication, voice activity signal

7,71a,72b,73b sender, sending unit

8,81b,82a,83a receiver, receiving unit

9,9a,9b output transducer unit, output transducer, loudspeaker

10 individual, user

11a,11b signals to be perceived by user

14 source of wanted signals, speaker

15 source of unwanted signals

78 link, communication link, wireless link

S2a,S2b audio signals

S4,S4a,S4b preprocessed audio signals

S5a,S5b noise-filtered audio signals

1: A binaural hearing system (1) comprising
ITF means (3;3a,3b) for providing at least one interaural transfer function (30;30a,30b);
noise reduction means (5;5a,5b) for performing noise reduction in dependence of said at least one interaural transfer function.

2: The binaural hearing system according to claim 1, comprising
a first (2a) and a second (2b) input transducer unit;
said ITF means (3;3a,3b) having an ITF output for outputting said at least one interaural transfer function (30;30a,30b), and said noise reduction means (5;5a,5b) comprising a first (5a) and a second (5b) adaptive filtering unit, each having at least a first and a second audio signal input and a control input (55a;55b), for filtering audio signals inputted to said audio signal inputs in dependence of data received at said control input, wherein each of said first audio signal inputs is operationally connected to said first input transducer unit (2a) and each of said second audio signal inputs is operationally connected to said second input transducer unit (2b), and wherein each of said control inputs is operationally connected to said ITF output.

3: The binaural hearing system according to claim 2, said filtering in said first and second adaptive filtering units depends in essentially the same way on said at least one interaural transfer function.

4: The binaural hearing system according to claim 2, wherein said first and second adaptive filtering units (5a;5b) each have a set of filtering coefficients, which depend on said at least one interaural transfer function.

5: The binaural hearing system according to claim 2, comprising
a first and a second output transducer unit (9a,9b) for receiving audio signals and converting these into signals (11a,11b) to be perceived by an individual (10) using said binaural hearing system;
said first adaptive filtering unit (5a) comprising an audio signal output operationally connected to said first output transducer unit (9a), and said second adaptive filtering unit (5b) comprising an audio signal output operationally connected to said second output transducer unit (9b).

6: The binaural hearing system according to claim 2, said first and second adaptive filtering units (5a,5b) each having an optimization function comprising a first term describing a desired interaural transfer function for wanted signal components and a second term describing a desired interaural transfer function for unwanted signal components, such as to aim at realizing that a transfer function describing the relation between wanted audio signal components outputted from said first and second adapative filtering units corresponds to said desired interaural transfer function for wanted signal components, and at realizing that a transfer function describing the relation between unwanted audio signal components outputted from said first and second adapative filtering units corresponds to said desired interaural transfer function for unwanted signal components.

7: The binaural hearing system according to claim 2, said ITF means (3;3a,3b) comprising a first and a second input, for obtaining an interaural transfer function (30;30a,30b) from audio signals inputted to said first and second inputs, wherein said first and second inputs are operationally connected to said first and second input transducer unit (2a;2b), respectively.

8: The binaural hearing system according to claim 7, comprising at least one detecting unit (6a;6b) operationally connected to at least one of said first and second input transducer units (2a,2b), and having an output operationally connected to said control input (55a;55b) of at least one of said first and second adaptive filters (5a;5b), for deciding whether audio signals received from said at least one of said input transducer units are considered wanted signals or unwanted signals.

9: The binaural hearing system according to claim 2, wherein said first and second adaptive filtering units comprise at least one Wiener filter each.

10: The binaural hearing system according to claim 1, comprising
a first and a second device (1a;1b);
a first and a second input transducer unit (2a;2b), said first input transducer unit comprising at least two input transducers (21a;22a);
a preprocessing unit (4a;4b) comprising at least two audio signal inputs operationally connected to one of said at least two input transducers each, and comprising an audio signal output for outputting preprocessed audio signals (S4a;S4b) obtained by processing audio signals (S2a;S2b) received at said at least two audio signal inputs;
a sending unit (7) comprised in said first device (1a) and operationally connected to said audio signal output of said preprocessing unit;
a receiving unit (8) comprised in said second device (1b) and operationally connectable to said sending unit via a communication link (78);
said noise reduction (5) means comprising an adaptive filtering unit having at least a first and a second audio signal input, for filtering audio signals inputted to said audio signal inputs, wherein said first audio signal inputs is operationally connected to said receiving unit, and said second audio signal input is operationally connected to said second input transducer unit.

11: The binaural hearing system according to claim 1, comprising
a first (1a) and a second hearing device (1b);
a first (2a) and a second (2b) input transducer unit comprised in said first and second hearing device, respectively, each comprising at least two input transducers (21a,22a; 21b,22b);
a first preprocessing unit (4a) comprised in said first hearing device (1a), comprising at least a first and a second audio signal input, each operationally connected to one of said at least two input transducers (21a;22a) of said first input transducer unit (2a), and comprising an audio signal output for outputting preprocessed audio signals (S4a) obtained by preprocessing audio signals received at said first and second audio signal inputs;
a second preprocessing unit (4b) comprised in said second hearing device (2b), comprising at least a first and a second audio signal input, each operationally connected to one of said at least two input transducers (21b,22b) of said second input transducer unit (2b), and comprising an audio signal output for outputting preprocessed audio signals (S4b) obtained by preprocessing audio signals received at said first and second audio signal inputs;
a first sending unit (71a) comprised in said first hearing device (1a), and operationally connected to said audio signal output of said first preprocessing unit (4a);
a second sending unit (72b) comprised in said second hearing device (1b), and operationally connected to said audio signal output of said second preprocessing unit (4b);
a first receiving unit (82a) comprised in said first device (1a) and operationally connectable to said second sending unit (72b) via a communication link;
a second receiving unit (81b) comprised in said second device (2b) and operationally connectable to said first sending unit (71a) via a communication link;
said noise reduction means (5) comprising a first (5a) and a second (5b) adaptive filtering unit, each having at least a first and a second audio signal input, for filtering audio signals inputted to said audio signal inputs, wherein
said first audio signal input of said first adaptive filtering unit (5a) is operationally connected to said first input transducer unit (2a);
said second audio signal input of said first adaptive filtering unit is operationally connected to said first receiving unit (82a);
said first audio signal input of said second adaptive filtering unit (5b) is operationally connected to said second receiving unit (81b);
said second audio signal input of said second adaptive filtering unit (5b) is operationally connected to said second input transducer unit (2b).

12: The binaural hearing system according to claim 1, which is two hearing aids (1a,1b), and wherein said noise reduction means are two binaural Wiener filters (5a,5b).

13: The binaural hearing system according to claim 12, wherein said two binaural Wiener filters each have a cost function incorporating two terms accounting for interaural transfer functions of speech and noise components.

14: The binaural hearing system according to claim 13, wherein each of said cost functions incorporates speech distortion weighted terms.

15: The binaural hearing system according to claim 12, wherein said binaural Wiener filters are multichannel Wiener filters.

16: The binaural hearing system according to claim 12, with M microphones on each hearing aid, wherein said ITF means are means calculating said at least one interaural transfer function by dividing signals received by one of said M microphones on a first of said two hearing aids by signals received by one of said M microphones on the second of said two hearing aids.

17: The binaural hearing system according to claim 12, wherein said ITF means (5) are means calculating said at least one interaural transfer function as a quotient of two head-related transfer functions, both of which are head-related transfer functions for the same angle, with one head-related transfer function for the left ear and one head-related transfer functions for the right ear.

18: The binaural hearing system according to claim 1, wherein said at least one interaural transfer function is one interaural transfer function of speech components and one interaural transfer function of noise components.

19: A method of operating a binaural hearing system (1), said method comprising the steps of
providing at least one interaural transfer function (30; 30a,30b);
performing noise reduction in dependence of said at least one interaural transfer function.

20: The method according to claim 19, wherein said binaural hearing system comprises a first (2a) and a second (2b) input transducer unit and a first (5a) and a second (5b) adaptive filtering unit, said method comprising the steps of
obtaining first audio signals (S2a) by means of said first input transducer unit (2a);
obtaining second audio signals (S2b) by means of said second input transducer unit (2b);
inputting said first audio signals or audio signals derived therefrom to said first adaptive filtering unit (5a) and to said second adaptive filtering unit (5b);
inputting said second audio signals or audio signals derived therefrom to said first adaptive filtering unit and to said second adaptive filtering unit;
in said first and second adaptive filtering units: filtering said audio signals inputted to the corresponding adaptive filtering unit in dependence of said least one interaural transfer function.

21: The method according to claim 20, wherein said filtering in said first and second adaptive filtering units depends in essentially the same way on said at least one interaural transfer function.

22: The method according to claim 20, comprising the steps of
converting audio signals (S5a) obtained by said filtering in said first adaptive filtering unit or audio signals derived therefrom into signals (11a) to be perceived by an individual (10) using said binaural hearing system (1);
converting audio signals (S5b) obtained by said filtering in said second adaptive filtering unit (5b) or audio signals derived therefrom into signals (11b) to be perceived by said individual (10).

23: The method according to claim 20, comprising the step of obtaining said at least one interaural transfer function from calculating a relation between said first audio signals or audio signals derived therefrom and said second audio signals or audio signals derived therefrom.

24: The method according to claim 23, comprising the steps of
analyzing said first audio signals and/or said second audio signals and/or audio signals derived from said first and/or said second audio signals;
based on the result of this analysis: generating an indication whether the analyzed audio signals are considered wanted signals or unwanted signals.

25: The method according to claim 24, wherein said first and second adaptive filtering units each have an optimization function comprising a first term describing a desired interaural transfer function for wanted signal components and a second term describing a desired interaural transfer function for unwanted signal components, said method comprising the step of
assigning based on said indication, said obtained interaural transfer function to either said first or said second term.

26: The method according to claim 20, wherein said first and second adaptive filtering units both perform Wiener filtering.

27: The method according to claim 19, said binaural hearing system (1) comprising a first (1a) and a second (1b) device and a first (2a)and a second (2b) input transducer unit and an adaptive filtering unit (5) having at least a first and a second audio signal input, said first input transducer unit comprising at least two input transducers (21a;22a), said method comprising the steps of
obtaining preprocessed audio signals (S4a) by processing audio signals derived by each of said at least two input transducers;
transmitting said preprocessed audio signals from said first to said second device;
after said transmission: feeding said preprocessed audio signals or signals derived therefrom to said first audio signal input;
feeding audio signals obtained by said second input transducer unit or signals derived therefrom to said second audio signal input;
performing noise reduction by filtering audio signals inputted to said audio signal inputs of said adaptive filtering unit.

28: The method according to claim 19, wherein said binaural hearing system is two hearing aids (1a,1b), and said noise reduction is binaural noise reduction through Wiener filtering.

29: The method according to claim 28, wherein said Wiener filtering is carried out by two binaural Wiener filters, each having a cost function incorporating two terms accounting for interaural transfer functions of speech and noise components.

30: The method according to claim 29, wherein each of said cost functions incorporates speech distortion weighted terms.

31: The method according to claim 28, wherein said Wiener filtering is multichannel Wiener filtering.

32: The method according to claim 28, said two hearing aids each comprising M microphones, said method comprising the step of
calculating said at least one interaural transfer function by dividing signals received by one of said M microphones on a first of said two hearing aids by signals received by one of said M microphones on the second of said two hearing aids.

33: The method according to claim 28, comprising the step of
calculating said at least one interaural transfer function as a quotient of two head-related transfer functions, both of which are head-related transfer functions for the same angle, with one head-related transfer function for the left ear and one head-related transfer functions for the right ear.
